(19) United States
(12) Patent Application Publication
(10) Pub. No.: US 2026/0021392 A1
(43) Pub. Date: Jan. 22, 2026

(54) VIRTUAL OBJECT SHARING

(71) Applicant: TENCENT TECHNOLOGY (SHENZHEN) COMPANY LIMITED, Shenzhen (CN)

(72) Inventors: Jieqi XIE, Shenzhen (CN); Chuhui WANG, Shenzhen (CN)

(73) Assignee: TENCENT TECHNOLOGY (SHENZHEN) COMPANY LIMITED, Shenzhen (CN)

(21) Appl. No.: 19/340,624

(22) Filed: Sep. 25, 2025

Related U.S. Application Data
(63) Continuation of application No. PCT/CN2024/123888, filed on Oct. 10, 2024.

(30) Foreign Application Priority Data
Dec. 15, 2023 (CN) 202311736309.2

(51) Int. Cl. A63F 13/52; A63F 13/533; A63F 13/55

(52) U.S. Cl. CPC A63F 13/52; A63F 13/533; A63F 13/55

(57) ABSTRACT

In a method, at least one first virtual object possessed by a first account is displayed in a first object display region. The first virtual object is configured to perform first one or more virtual interaction operations in a virtual environment. A sharing prompt region and at least one second virtual object possessed by a second account are displayed in the sharing prompt region, based on a first interaction operation on a target virtual object. The second virtual object is configured to perform second one or more virtual interaction operations. Based on a second interaction operation, the display of the target virtual object in the first object display region is stopped, and object sharing information is transmitted to the second account.

### RELATED APPLICATIONS

The present application is a continuation of International Application No. PCT/CN2024/123888, filed on Oct. 10, 2024, which claims priority to Chinese Patent Application No. 202311736309.2, filed on Dec. 15, 2023. The entire disclosures of the prior applications are hereby incorporated by reference.

### FIELD OF THE TECHNOLOGY

The present disclosure relates to the field of computers, including a virtual object sharing method and apparatus, a virtual object obtaining method and apparatus, a storage medium, a program product, and an electronic device.

### BACKGROUND OF THE DISCLOSURE

Currently, in various arena game applications, teammates may usually team up to battle. Some cooperative operations may be performed between accounts having a teammate relationship. For example, a virtual object may be shared between the teammates.

Because a virtual object sharing operation between the teammates is usually performed based on communication between the teammates, the teammates may choose to communicate with each other by using voice and text or by marking a virtual object in a virtual scene.

In operation, marking the virtual object can bring relatively little information. Consequently, there is an information gap between the teammates participating in sharing, and finally, there is a technical problem of relatively low communication efficiency in a virtual object sharing process.

### SUMMARY

Embodiments of this disclosure provide a virtual object sharing method and apparatus, a virtual object obtaining method and apparatus, a storage medium, a program product, and an electronic device, to improve at least communication efficiency in a virtual object sharing process.

An embodiment of this disclosure provides a virtual object sharing method. In the virtual object sharing method, at least one first virtual object possessed by a first account is displayed in a first object display region. The first virtual object is configured to perform first one or more virtual interaction operations in a virtual environment. A sharing prompt region and at least one second virtual object possessed by a second account are displayed in the sharing prompt region, based on a first interaction operation on a target virtual object in the at least one first virtual object. The second virtual object is configured to perform second one or more virtual interaction operations in the virtual environment. Based on a second interaction operation, the display of the target virtual object in the first object display region is stopped, and object sharing information of a virtual object transfer operation is transmitted to the second account. The virtual object transfer operation is configured to transfer the target virtual object from the first account to the second account based on the object sharing information.

An embodiment of this disclosure provides a virtual object sharing apparatus. The virtual object sharing apparatus includes processing circuitry configured to display, in a first object display region, at least one first virtual object possessed by a first account. The first virtual object is configured to perform first one or more virtual interaction operations in a virtual environment. The processing circuitry is configured to display, in a sharing prompt region, at least one second virtual object possessed by a second account, based on a first interaction operation on a target virtual object in the at least one first virtual object. The second virtual object is configured to perform second one or more virtual interaction operations in the virtual environment. Based on a second interaction operation, the processing circuitry is configured to stop the display of the target virtual object in the first object display region; and to transmit object sharing information of a virtual object transfer operation to the second account. The virtual object transfer operation is configured to transfer the target virtual object from the first account to the second account based on the object sharing information.

An embodiment of this disclosure provides a non-transitory computer-readable storage medium. The non-transitory computer-readable storage medium stores instructions, which when executed by a processor, cause the processor to perform displaying, in a first object display region, at least one first virtual object possessed by a first account. The first virtual object is configured to perform first one or more virtual interaction operations in a virtual environment. The instructions, which when executed by the processor, cause the processor to perform displaying, in a sharing prompt region, at least one second virtual object possessed by a second account, based on a first interaction operation on a target virtual object in the at least one first virtual object. The second virtual object is configured to perform second one or more virtual interaction operations in the virtual environment. The instructions, which when executed by the processor, cause the processor to perform, based on a second interaction operation, stopping the display of the target virtual object in the first object display region, and transmitting object sharing information of a virtual object transfer operation to the second account. The virtual object transfer operation is configured to transfer the target virtual object from the first account to the second account based on the object sharing information.

An embodiment of this disclosure provides a virtual object obtaining method. In the virtual object obtaining method, at least one second virtual object possessed by a second account is displayed in a second object display region. The second virtual object is configured to perform second one or more virtual interaction operations in a virtual environment. A sharing prompt region and, in the sharing prompt region, a target virtual object possessed by a first account are displayed. The target virtual object is configured to perform first one or more virtual interaction operations in the virtual environment. When object sharing information associated with the first account is received, the target virtual object is displayed by processing circuitry in the second object display region, and the display of the sharing prompt region is stopped by the processing circuitry.

An embodiment of this disclosure provides a virtual object obtaining apparatus. The virtual object obtaining apparatus includes processing circuitry configured to display, in a second object display region, at least one second virtual object possessed by a second account. The second virtual object is configured to perform second one or more virtual interaction operations in a virtual environment. The processing circuitry is configured to display a sharing prompt region and, in the sharing prompt region, a target virtual object possessed by a first account. The target virtual object is configured to perform first one or more virtual interaction operations in the virtual environment. The processing circuitry is configured to, when object sharing information associated with the first account is received, display the target virtual object in the second object display region, and stop the display of the sharing prompt region.

An embodiment of this disclosure provides a non-transitory computer-readable storage medium. The non-transitory computer-readable storage medium stores instructions, which when executed by a processor, cause the processor to perform displaying, in a second object display region, at least one second virtual object possessed by a second account. The second virtual object is configured to perform second one or more virtual interaction operations in a virtual environment. The instructions, which when executed by the processor, cause the processor to perform displaying a sharing prompt region and, in the sharing prompt region, a target virtual object possessed by a first account. The target virtual object is configured to perform first one or more virtual interaction operations in the virtual environment. The instructions, which when executed by the processor, cause the processor to perform, when object sharing information associated with the first account is received, displaying the target virtual object in the second object display region; and stopping, by the processing circuitry, the display of the sharing prompt region.

An embodiment of this disclosure provides a virtual object sharing method, the method being performed by an electronic device, and including: displaying, in a first object display region, at least one first virtual object possessed by a first account, the first virtual object being configured for performing a virtual interaction operation in a virtual scene; displaying a sharing prompt region, and displaying, in the sharing prompt region, a second virtual object currently possessed by a second account, in response to a first interaction operation on a target virtual object in the at least one first virtual object, the second account and the first account being in a same interaction camp, and the second virtual object being configured for performing the virtual interaction operation in the virtual scene associated with the second account; and canceling displaying of the target virtual object in the first object display region, and transmitting object sharing information to the second account, in response to a second interaction operation, the object sharing information being configured for transferring the target virtual object to the second account for possessing.

An embodiment of this disclosure provides a virtual object obtaining method, the method being performed by an electronic device, and including: displaying, in a second object display region, at least one second virtual object possessed by a second account, the second virtual object being configured for performing a virtual interaction operation in a virtual scene; displaying a sharing prompt region, and displaying a currently shared target virtual object in the sharing prompt region, when a first account performs a first interaction operation on the target virtual object, the first account and the second account being in a same interaction camp, and the target virtual object being configured for performing the virtual interaction operation in the virtual scene associated with the first account; and displaying the target virtual object in the second object display region, and canceling displaying of the sharing prompt region, when receiving object sharing information transmitted by the first account.

An embodiment of this disclosure provides a virtual object sharing apparatus, including: a first display unit, configured to: display, in a first object display region, at least one first virtual object possessed by a first account, the first virtual object being configured for performing a virtual interaction operation in a virtual scene; and display a sharing prompt region, and display, in the sharing prompt region, a second virtual object currently possessed by a second account, in response to a first interaction operation on a target virtual object in the at least one first virtual object, the second account and the first account being in a same interaction camp, and the second virtual object being configured for performing the virtual interaction operation in the virtual scene associated with the second account; and a sharing unit, configured to: cancel displaying of the target virtual object in the first object display region, and transmit object sharing information to the second account, in response to a second interaction operation, the object sharing information being configured for transferring the target virtual object to the second account for possessing.

An embodiment of this disclosure provides a virtual object obtaining apparatus, including: a second display unit, configured to: display, in a second object display region, at least one second virtual object possessed by a second account, the second virtual object being configured for performing a virtual interaction operation in a virtual scene; and display a sharing prompt region, and display a currently shared target virtual object in the sharing prompt region, when a first account performs a first interaction operation on the target virtual object, the first account and the second account being in a same interaction camp, and the target virtual object being configured for performing the virtual interaction operation in the virtual scene associated with the first account; and an obtaining unit, configured to: display the target virtual object in the second object display region, and cancel displaying of the sharing prompt region, when receiving object sharing information transmitted by the first account.

An embodiment of this disclosure provides a non-transitory computer-readable storage medium, the non-transitory computer-readable storage medium including a computer program or computer-executable instructions; and when the computer program or the computer-executable instructions are run by a processor, the virtual object sharing method provided in one or more embodiments of this disclosure or the virtual object obtaining method provided in one or more embodiments of this disclosure being performed.

An embodiment of this disclosure provides a computer program product. The computer program product includes a computer program or computer-executable instructions. The computer program or the computer-executable instructions are stored in a non-transitory computer-readable storage medium. A processor of an electronic device reads the computer program or the computer-executable instructions from the non-transitory computer-readable storage medium. When the processor executes the computer program or the computer-executable instructions, the virtual object sharing method provided in one or more embodiments of this disclosure or the virtual object obtaining method provided in one or more embodiments of this disclosure is implemented.

An embodiment of this disclosure provides an electronic device, including a memory and a processor, the memory having a computer program or computer-executable instructions stored therein; and when the processor is configured to execute the computer program or the computer-executable instructions, the virtual object sharing method provided in one or more embodiments of this disclosure or the virtual object obtaining method provided in one or more embodiments of this disclosure being implemented.

In one or more embodiments of this disclosure, the at least one first virtual object possessed by the first account is displayed in the first object display region, the first virtual object being configured for performing the virtual interaction operation in the virtual scene; the sharing prompt region is displayed, and the second virtual object currently possessed by the second account is displayed in the sharing prompt region, in response to the first interaction operation on the target virtual object in the at least one first virtual object, the second account and the first account being in the same interaction camp, and the second virtual object being configured for performing the virtual interaction operation in the virtual scene associated with the second account; and displaying of the target virtual object is canceled in the first object display region, and the object sharing information is transmitted to the second account, in response to the second interaction operation, the object sharing information being configured for transferring the target virtual object to the second account for possessing, so that efficient communication between different accounts in a virtual object sharing process is implemented.

In the foregoing implementations of this disclosure, in the process in which the first account shares a virtual object with the second account, a virtual object that has been currently possessed by the second account, namely, a teammate account, may be displayed on an interface in response to the first interaction operation, to assist the first account in determining whether the second account needs the currently selected target virtual object. In this way, a possessing status of the virtual object of the second account can be quickly learned of without initiating voice communication or transmitting text information to the second account, so that communication efficiency between the different accounts in the virtual object sharing process is improved. That is, communication efficiency in the virtual object sharing process is improved.

### BRIEF DESCRIPTION OF THE DRAWINGS

The accompanying drawings described herein are for providing a further understanding of this disclosure, and form a part of this disclosure. Embodiments of this disclosure and descriptions thereof are for explaining this disclosure, and do not constitute limitations on this disclosure. In the accompanying drawings:

FIG. 1 is a schematic diagram of a hardware environment of a virtual object sharing method according to an embodiment of this disclosure.

FIG. 2 is a flowchart of a virtual object sharing method according to an embodiment of this disclosure.

FIG. 3 is a schematic diagram of a virtual object sharing method according to an embodiment of this disclosure.

FIG. 4 is a schematic diagram of another virtual object sharing method according to an embodiment of this disclosure.

FIG. 5 is a schematic diagram of still another virtual object sharing method according to an embodiment of this disclosure.

FIG. 6 is a schematic diagram of still another virtual object sharing method according to an embodiment of this disclosure.

FIG. 7 is a schematic diagram of still another virtual object sharing method according to an embodiment of this disclosure.

FIG. 8 is a schematic diagram of still another virtual object sharing method according to an embodiment of this disclosure.

FIG. 9 is a schematic diagram of still another virtual object sharing method according to an embodiment of this disclosure.

FIG. 10 is a schematic diagram of still another virtual object sharing method according to an embodiment of this disclosure.

FIG. 11 is a schematic diagram of still another virtual object sharing method according to an embodiment of this disclosure.

FIG. 12 is a schematic diagram of still another virtual object sharing method according to an embodiment of this disclosure.

FIG. 13 is a schematic diagram of still another virtual object sharing method according to an embodiment of this disclosure.

FIG. 14 is a schematic diagram of still another virtual object sharing method according to an embodiment of this disclosure.

FIG. 15 is a flowchart of a virtual object obtaining method according to an embodiment of this disclosure.

FIG. 16 is a schematic diagram of a virtual object obtaining method according to an embodiment of this disclosure.

FIG. 17 is a schematic diagram of another virtual object obtaining method according to an embodiment of this disclosure.

FIG. 18 is a flowchart of another virtual object sharing method according to an embodiment of this disclosure.

FIG. 19 is a flowchart of another virtual object obtaining method according to an embodiment of this disclosure.

FIG. 20 is a schematic structural diagram of a virtual object sharing apparatus according to an embodiment of this disclosure.

FIG. 21 is a schematic structural diagram of an electronic device according to an embodiment of this disclosure.

FIG. 22 is a schematic structural diagram of a virtual object obtaining apparatus according to an embodiment of this disclosure.

FIG. 23 is a schematic structural diagram of another electronic device according to an embodiment of this disclosure.

### DESCRIPTION OF EMBODIMENTS

The following describes the technical solutions in one or more embodiments of this disclosure with reference to the accompanying drawings. The described embodiments are only some of embodiments of this disclosure rather than all of embodiments. Other embodiments are within the scope of the disclosure.

In the specification, claims, and accompanying drawings of this disclosure, terms such as “first” and “second” are configured for distinguishing between similar objects, but are not necessarily configured for describe a particular order or sequence. Data or elements used in such a way are interchanged in proper circumstances, so that embodiments of this disclosure described herein can be implemented in other orders than the orders illustrated or described herein. In addition, the terms “include” and “have” and any variant thereof are intended to cover the non-exclusive inclusion. For example, a process, method, system, product, or device that includes a series of steps or units is not necessarily limited to those expressly listed steps or units, but may include other steps or units not expressly listed or inherent to such a process, method, product, or device.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

Before embodiments of this disclosure are described in further detail, examples of terms in one or more embodiments of this disclosure are described, and the following explanations are applicable to the terms in one or more embodiments of this disclosure. The descriptions of the terms are provided as examples only and are not intended to limit the scope of the disclosure.

(1) A virtual scene may correspond to a virtual scene displayed (or provided) when an application (for example, a game) runs on a terminal. The virtual scene may be a simulated environment of the real world, may be a semi-simulated and semi-fictional virtual environment, or may be a purely fictional virtual environment. The virtual scene may be any one of a 2-dimensional virtual scene, a 2.5-dimensional virtual scene, or a 3-dimensional virtual scene. This is not limited in one or more embodiments of this disclosure.

(2) Virtual objects may correspond to images of various people and objects that may perform interaction within the virtual scene, or movable objects in the virtual scene, for example, a virtual prop in the virtual scene and a virtual role controlled by an account of a user in the virtual scene. In one or more embodiments of this disclosure, the virtual object is configured for performing one or more virtual interaction operations in the virtual scene. The virtual interaction operation herein is an interaction operation between the virtual objects in the virtual scene, for example, a virtual attack operation, a virtual defense operation, or a virtual dodge operation between two virtual objects.

(3) The interaction operation may correspond to an operation performed when the user makes a related decision such as controlling or instruction giving on the virtual object in the virtual scene, for example, an operation of selecting a particular virtual object from possessed virtual objects or an operation of sharing the selected virtual object with a teammate. Different interaction operations in one or more embodiments of this disclosure may be distinguished by using a first interaction operation, a second interaction operation, and the like.

(4) The account may correspond to a personal account created by the user in the application (for example, the game), and may correspond to a unique identifier of the user in the application. The game is used as an example. The account is an identity and a tool of the user for game participation, game data storage, and game role management. In one or more embodiments of this disclosure, accounts of different users may be distinguished by using a first account and a second account, and virtual objects controlled by different accounts may be distinguished by using a first virtual object and a second virtual object.

(5) A current interaction interface may correspond to a visual (for example, a virtual scene) and operational (for example, an interaction operation) interface that is provided by the application for the user at a current moment and that is configured for interaction, and may include content such as a function that can be operated by the user and visual information provided for the user. In one or more embodiments of this disclosure, an object display region may be set on the current interaction interface, and is configured for displaying the virtual object owned by the account of the user. An object interaction region may further be set on the current interaction interface, and is configured for displaying the virtual scene provided by the application, so that when entering the object interaction region, the virtual object starts to perform the virtual interaction operation.

(6) A sharing prompt region may correspond to a region configured for providing current statuses and operation processes of two sharing parties in a virtual object sharing process. Based on the sharing prompt region, the two sharing parties can view a current status and an operation process of the other party in real time, to facilitate communication between the two sharing parties.

(7) Object sharing information may correspond to information usable to facilitate a virtual object transfer operation when a virtual object possessed by a sharing party is transferred to a receiving party for possessing. The object sharing information may include an identifier of the virtual object that needs to be transferred.

(8) An object association relationship may correspond to an interaction relationship, for example, a mutual-cooperation or mutual-refraining relationship, between the virtual objects. In this way, the object association relationship may be the cooperation relationship between the virtual objects (that is, two or more virtual objects may cooperate to generate a better interaction effect) or the refraining relationship between the virtual objects (that is, two or more virtual objects may conflict in attributes or one party may suppress another party, which makes cooperation difficult).

(9) Sharing prompt information may correspond to information prompting a benefit that may be brought to the receiving party related to transfer of the virtual object. For example, a level of a virtual object of the receiving party is increased. In this way, based on the sharing prompt information, the sharing party can determine the benefit that the transfer of the virtual object can bring to the receiving party. In this way, it can be more beneficial for the sharing party to determine whether to transfer the virtual object to the receiving party.

(10) A virtual gain effect on the receiving party may correspond to a group capability gain triggered when the virtual object possessed by the account reaches a condition, and virtual objects participating in the group energy gain may all obtain attribute bonuses or special capabilities. For example, health values or crit rates of the virtual objects are increased, or hidden skills of the virtual objects are triggered.

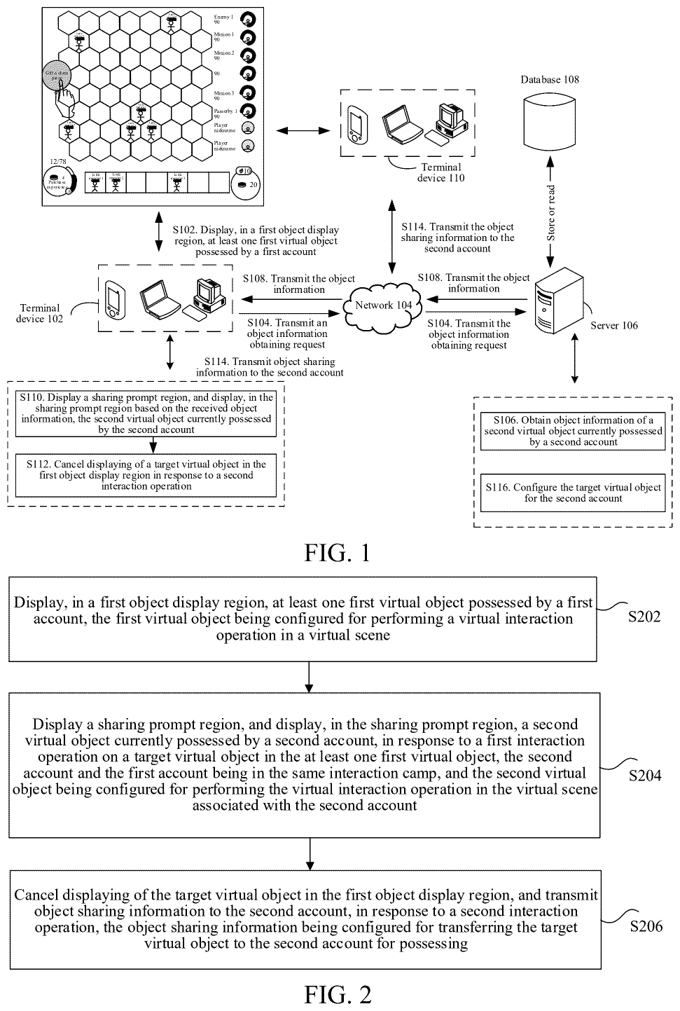

An embodiment of this disclosure provides a virtual object sharing method. In an implementation, the foregoing virtual object sharing method may be applied to, but is not limited to, a virtual object sharing system in a hardware environment shown in FIG. 1. The virtual object sharing system may include, but is not limited to, a terminal device 102, a network 104, a server 106, a database 108, and a terminal device 110. A target client runs in the terminal device 102 and the terminal device 110 separately (as shown in FIG. 1, an example in which the target client is a game application client is used). The terminal device 102 and the terminal device 110 separately include a human-computer interaction screen, a processor, and a memory. The human-computer interaction screen is configured to display a virtual game scene (a virtual game scene shown in FIG. 1), and is further configured to provide a human-computer interaction interface to receive a human-computer interaction operation for controlling a virtual object controlled in the virtual scene, where the virtual object completes a game task set in the virtual scene. The processor is configured to generate an interaction instruction in response to the human-computer interaction operation, and transmit the interaction instruction to the server. The memory is configured to store related attribute data, such as attribute information of the controlled virtual object and attribute information of a possessed virtual prop. The attribute information herein may include, but is not limited to, information for identifying an identity, a current location, and the like thereof. The client that controls a first virtual object by using a first account runs in the terminal device 102. Correspondingly, the client that controls a second virtual object by using a second account runs in the terminal device 110. The second virtual object and the first virtual object herein may perform a virtual interaction operation in the virtual scene, for example, a virtual attack operation, a virtual defense operation, and a virtual skill casting operation. When the first account and the second account have a friendship, the first virtual object and the second virtual object may further perform virtual cooperation and confrontation operations.

Furthermore, the server 106 includes a processing engine. The processing engine is configured to perform a storage or reading operation on the database 108. Specifically, the processing engine reads, from the database 108, information about a virtual scene of each account, information about a virtual object possessed by the account, and information about an operation performed by the account.

It is assumed that, in FIG. 1, the first account logs in to the terminal device 102, and the second account that is in the same camp as the first account logs in to the terminal device 110. A specific process of this embodiment includes the following operations: First, the terminal device 102 to which the first account logs in performs operation S102, that is displays, in a first object display region, at least one first virtual object possessed by the first account, the first virtual object being configured for performing a virtual interaction operation in a virtual scene. Then, in response to a first interaction operation performed by the first account on a target virtual object in the at least one first virtual object, the terminal device 102 performs S104, to be specific, transmits an object information obtaining request to the server 106 through the network 104. The server 106 performs operation S106, to be specific, obtains object information of the second virtual object currently possessed by the second account, and performs S108, to be specific, transmits the object information to the terminal device 102 through the network 104.

The terminal device 102 performs S110 to S114, to be specific, displays a sharing prompt region, and displays, in the sharing prompt region based on the received object information, the second virtual object currently possessed by the second account, the second account and the first account being in the same interaction camp, and the second virtual object being configured for performing the virtual interaction operation in the virtual scene associated with the second account; and cancels displaying of the target virtual object in the first object display region, and transmits, through the network 104, object sharing information to the second account that logs in to the terminal device 110, in response to a second interaction operation, the object sharing information being configured for transferring the target virtual object to the second account for possessing.

In addition, the server 106 performs operation S116, to be specific, configures the target virtual object for the second account.

In another implementation, when a terminal device has the same type of a terminal device 102 or a terminal device 110 has a relatively strong computing processing capability, the foregoing operations S106 and S116 may alternatively be completed by another terminal device. This is an example. This is not limited in any way in this embodiment.

In some embodiments, the foregoing terminal device may be a terminal device configured with the target client, and may include, but is not limited to, at least one of the following: a smartphone, a notebook computer, a tablet computer, a palmtop computer, a mobile Internet device (MID), a pad, a desktop computer, a smart television, or the like. The target client may be a client that supports providing of the virtual scene, such as a video client, an instant messaging client, a browser client, or an education client. The foregoing network may include, but is not limited to, a wired network and a wireless network. The wired network includes a local area network, a metropolitan area network, and a wide area network. The wireless network includes Bluetooth, Wi-Fi, and other networks implementing wireless communication. The foregoing server may be a single server, a server cluster including a plurality of servers, or a cloud server. The foregoing is merely an example. This is not limited in any way in this embodiment.

In some embodiments, the foregoing virtual object sharing method may be applied to, but is not limited to, a game-type terminal application (APP) that is for completing a given confrontation game task in the virtual scene, such as a multiplayer online battle arena (MOBA) application. The confrontation game task may be, but is not limited to, a virtual confrontation game task between a virtual object (for example, a virtual role) controlled by a player (namely, a user) and a virtual object controlled by another player. The foregoing virtual object sharing method may further be applied to a massively multiplayer online role-playing game (MMORPG)-type terminal application. In this type of game, a current player may complete a social game task in the game at a first viewing angle of a virtual object in a role-playing manner, for example, complete a game task together with another virtual object. The foregoing virtual object sharing method may further be applied to an auto battler (also referred to as auto chess)-type game. The auto battler-type game is a type of a tactical strategy-type game. In this type, players place virtual objects on a battle field of a grid shape at a preparation phase, and then the virtual objects automatically battle against each other. In some scenarios, the players do not need to further input an operation. The foregoing implementation of this disclosure may further be applied to, but is not limited to, an open world-type game. The open world means that a virtual scene in the game is completely free and open, a player may freely move forward to explore in any direction, and a distance between boundaries of various orientations is quite large. In addition, the virtual scene also includes simulation objects in various shapes and sizes, which can generate various physical collisions or interactions with a virtual object controlled by the player, artificial intelligence (AI), or the like. In the open world game, the player may control a game task completed by a virtual object through confrontation interaction.

The foregoing type of game task may be but is not limited to running in an application (for example, a game APP not running independently) in a form of a plug-in or a mini program, or running in an application (for example, a game APP running independently) in a game engine. A type of the foregoing game-type terminal application may include, but is not limited to, at least one of the following: a 2-dimensional (2D) game application, a 3-dimensional (3D) game application, a virtual reality (VR) game application, an augmented reality (AR) game application, or a mixed reality (MR) game application. The foregoing is merely an example. This is not limited in any way in this embodiment.

In one or more embodiments of this disclosure, the at least one first virtual object possessed by the first account is displayed in the first object display region, the first virtual object being configured for performing the virtual interaction operation in the virtual scene; the sharing prompt region is displayed, and the second virtual object currently possessed by the second account is displayed in the sharing prompt region, in response to the first interaction operation on the target virtual object in the at least one first virtual object, the second account and the first account being in the same interaction camp, and the second virtual object being configured for performing the virtual interaction operation in the virtual scene associated with the second account; and displaying of the target virtual object is canceled in the first object display region, and the object sharing information is transmitted to the second account, in response to the second interaction operation, the object sharing information being configured for transferring the target virtual object to the second account for possessing, so that efficient communication between different accounts, namely, different players, in an object sharing process is implemented.

In the foregoing implementations of this disclosure, in the process in which the first account shares the virtual object with the second account, the virtual object currently possessed by the teammate account may be displayed on the interface in response to the first interaction operation, which may help the first account to determine whether the second account needs the currently selected target virtual object, so that a possessing status of the virtual object of the second account may be quickly learned of without initiating voice communication or transmitting text information to the second account, thereby improving efficiency of communication between different accounts in the virtual object sharing process, and resolving the technical problem of relatively low efficiency of the existing communication manner. That is, communication efficiency in an object finding sharing process is improved.

In an embodiment of this disclosure, as shown in FIG. 2, the foregoing virtual object sharing method may be executed by an electronic device, and includes the following operations:

S202. Display, in a first object display region, at least one first virtual object possessed by a first account, the first virtual object being configured for performing a virtual interaction operation in a virtual scene (for example, in a virtual environment). In one example, at least one first virtual object possessed by a first account is displayed in a first object display region. The first virtual object is configured to perform first one or more virtual interaction operations in a virtual environment.

S204. Display a sharing prompt region, and display, in the sharing prompt region, a second virtual object currently possessed by a second account, in response to a first interaction operation on a target virtual object in the at least one first virtual object, the second account and the first account being in the same interaction camp, and the second virtual object being configured for performing the virtual interaction operation in the virtual scene associated with the second account. In one example, a sharing prompt region and at least one second virtual object possessed by a second account are displayed in the sharing prompt region, based on a first interaction operation on a target virtual object in the at least one first virtual object. The second virtual object is configured to perform second one or more virtual interaction operations in the virtual scene.

S206. Cancel displaying of the target virtual object in the first object display region, and transmit object sharing information to the second account, in response to a second interaction operation, the object sharing information being configured for transferring the target virtual object to the second account for possessing. In one example, the display of the target virtual object in the first object display region is stopped and object sharing information of a virtual object transfer operation is transmitted to the second account based on a second interaction operation. The virtual object transfer operation is configured to transfer the target virtual object from the first account to the second account based on the object sharing information.

In the virtual object sharing method provided in this disclosure, at least two accounts are included. The first account is an account that performs a virtual object sharing operation in the foregoing sharing method, namely, a sharing party. The second account is an account that receives a shared virtual object in the foregoing sharing method, namely, a receiving party. Operations S202 to S206 in the foregoing implementation of this disclosure may be method operations applied to a client to which the first account logs in.

The virtual object sharing method provided in this embodiment of this disclosure may be applied to, but is not limited to, a game application that can provide a function of communication between accounts. A game type of the game application may include, but is not limited to, a multiplayer online battle arena (MOBA) application, a massively multiplayer online role-playing game (MMORPG)-type game application, or an auto battler (also referred to as auto chess)-type game application. In this implementation, the foregoing object sharing application scene is not limited. In the foregoing type of game application, accounts may form an interaction camp in a team forming manner, to cooperatively complete a game task. In a process of completing the game task, accounts in the same interaction camp may communicate in a plurality of communication manners provided in the game. The communication manners may include, but are not limited to, voice communication and text communication.

The following describes the foregoing auto battler-type game task. In the auto battler-type game application, the game task may be an intra-match collectible hero card multiplayer turn-based arena task. There are N players in total in the game, and battles in pairs in one game turn. Each player in the game occupies one virtual battle field (namely, a virtual scene associated with the account), and fields of the two battling players are spliced in a battle phase, to battle on a spliced virtual battle field. Each game task turn includes two phases: preparation and battle. In the preparation phase, the players purchase chess pieces (namely, virtual objects) in a store, and arrange formations on a chessboard. In the battle phase, the formations of the two battling parties are locked, and the chess pieces automatically battle with each other until all chess pieces of one party are eliminated. The party whose chess pieces are all eliminated is a defeat party in this turn, and a health value (a battle resource) is deducted from the defeat party. After one turn ends, game turns are continuously repeated. Each player matches a new opponent until a health value of the player≤0, which results in elimination. The last remaining player wins the game (the first place).

In the foregoing type of game task, a virtual object replacement or sharing operation may be performed between the accounts in the same camp, and the foregoing virtual object may include, but is not limited to, a virtual prop, a virtual role, a virtual accessory, or the like. The foregoing virtual role may be a virtual role directly controlled by the account in a virtual scene, to complete the game task in the virtual scene, that is, perform a virtual interaction operation. The foregoing virtual prop may be configured on the foregoing virtual role, to provide a capability gain for the virtual role and assist in completing the game task. The foregoing virtual accessory may be configured for decorating the virtual role in the virtual scene.

Different accounts usually face different game progresses, and therefore, quantities and types of possessed virtual objects are usually different. Before a virtual object replacement or sharing operation is performed between the different accounts, a virtual object that has been currently possessed and a virtual object that has been possessed by a teammate account need to be considered, so that better resource allocation is implemented, to improve resource allocation efficiency. In a communication manner of marking the virtual object for communication provided in the game application, relatively little information can be provided, resulting in relatively low communication efficiency. In addition, in the voice communication manner provided in the game application, in addition to consuming more communication resources to transmit voice information, object accounts are further required to explicitly express respective requirements by using voice. However, when a novice player is not familiar with a game task, it is quite difficult to accurately express a virtual object needed by the novice player. Therefore, even if the voice communication manner is used, there is a significant problem of low communication efficiency. In addition, in a process of performing communication through text input, a problem that the novice player cannot accurately describe the virtual object needed by the novice player cannot be resolved, and there is also a technical problem of low input efficiency of text input.

To resolve the foregoing technical problem, this implementation provides the foregoing operations S202 to S206, to quickly obtain, in a process in which the first account (an account of a current player) performs virtual object sharing, information about the virtual object possessed by the second account, thereby improving communication efficiency in the virtual object sharing process.

In the foregoing operation S202 in this disclosure, a client interface displayed by the client to which the first account logs in, namely, a current interaction interface of the first account, may include the first object display region. The first object display region may be configured for displaying the at least one first virtual object possessed by the first account. A specific display style of the first object display region and an object type of the first virtual object may be determined based on a specific game application type.

For example, when the game application is the MOBA-type game application, each account controls a fixed virtual role to perform arena interaction in the virtual scene. Therefore, the virtual object that can be shared or replaced may be specifically the virtual prop. Correspondingly, the first object display region may be a prop bar configured for displaying a first virtual role controlled by the first account.

For another example, when the game application is the MMORPG-type game application, each account controls one virtual role to perform arena interaction in the virtual scene. Therefore, the virtual object that can be shared or replaced may be specifically the virtual prop. Correspondingly, the first object display region may be a virtual backpack configured for displaying a first virtual role controlled by the first account, and the virtual backpack may be configured for displaying a virtual prop currently possessed by the first virtual role, for example, a prop such as a virtual attack prop, a virtual helmet, or a virtual armor.

For example, when the game application is the auto battler-type game application, each account may obtain a plurality of virtual objects (which may be specifically virtual chess pieces) through resource replacement. Correspondingly, the first object display region may be specifically a battle preparation region, and is configured for displaying a virtual object that is currently possessed by the first account and that is in a waiting state. In some embodiments, a virtual scene in the auto battler-type game application may further include an object interaction region, namely, a battle region. A virtual object in the battle region may perform the virtual interaction operation without being interfered with by the first account. The virtual interaction operation may include, but is not limited to, a virtual attack operation, a virtual defense operation, and a virtual skill casting operation.

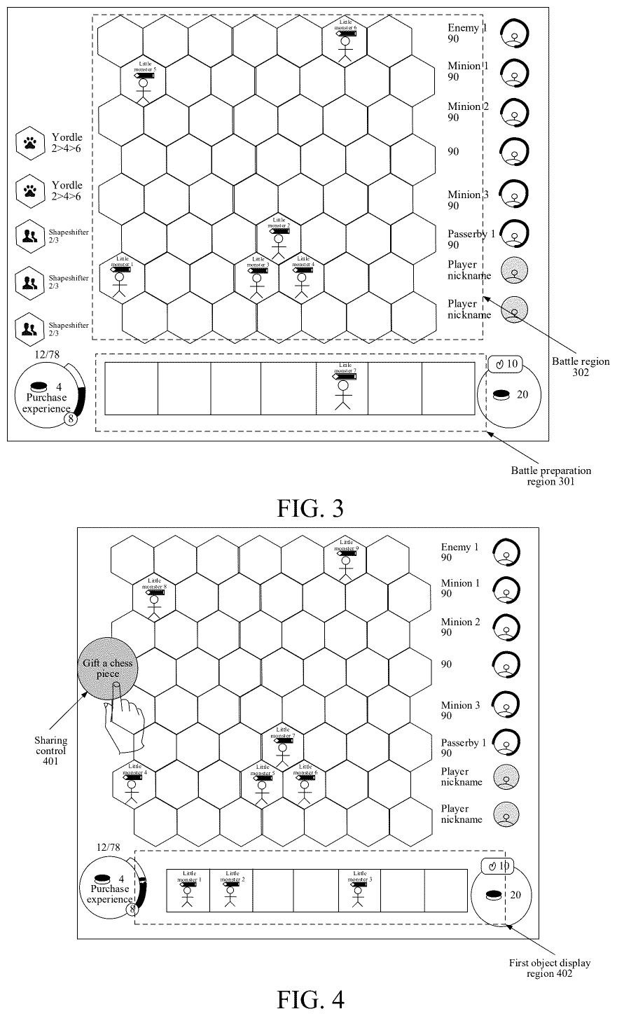

The following describes the game task in the auto battler-type game application with reference to FIG. 3. FIG. 3 shows the current interaction interface on the current client to which the first account logs in. A battle preparation region 301 in FIG. 3 is the first object display region, and displayed “Little monster 7” is the virtual object that is possessed by the first account and that is in the waiting state. A battle region 302 is the object interaction region on the current interaction interface of the first account, and “Little monster 1”, “Little monster 2”, “Little monster 3”, and “Little monster 4” shown in the battle region 302 are virtual objects that are selected by the first account and that are configured for participating in virtual confrontation interaction. Correspondingly, “Little monster 5” and “Little monster 6” shown in FIG. 3 are virtual objects that are selected by an opponent account and that are configured for participating in the virtual confrontation interaction. In the preparation phase in the auto battler-type game application, the first account and the opponent account may separately select the virtual objects participating in a battle, increase levels of the virtual objects participating in the battle, arrange locations of the virtual objects, and so on. In the battle phase, the virtual objects located on the chessboard and shown in FIG. 3 automatically battle, and a match result of a current round is determined when all virtual objects of one party are “eliminated”.

In some embodiments, the first interaction operation in the foregoing operation S204 may be an operation configured for determining the target virtual object in the first virtual object possessed by the first account. An operation type of the first interaction operation may include, but is not limited to, a click operation, a double-click operation, a long-press operation, or the like performed on the target virtual object. The first interaction operation may alternatively be a touch operation configured for triggering object sharing and object selection simultaneously, for example, may be dragging a sharing operation control displayed on the current interaction interface to a display region, namely, a target display region, that is in the first object display region and in which the target virtual object is located, or may be dragging an object identifier of the target virtual object to the sharing operation control. In this implementation, a specific type of the first interaction operation is not limited.

The sharing prompt region in the foregoing operation S204 may be configured for displaying the second virtual object currently possessed by the second account. The second account and the first account are in the same interaction camp. That is, the second account and the first account are in the same interaction camp, and have a teammate relationship.

In some implementations, the sharing prompt region may be a specific region on the current interaction interface of the first account. A display style of the sharing prompt region may include, but is not limited to, a region block diagram style, a region module style, and the like. A display location of the sharing prompt region may be any region location on the current interaction interface, provided that the sharing prompt region does not block the virtual object that performs the virtual interaction operation. A display location of the sharing prompt region may alternatively be a particular location on the current interaction interface, for example, a lower right corner or a center. A manner of displaying the sharing prompt region may be overlaid displaying on the current interaction interface. In some embodiments, transparency may be configured for the sharing prompt region, to reduce interference of the sharing prompt region to another display element on the current interaction interface. In this embodiment of this disclosure, a specific display manner of the sharing prompt region is not limited.

In some implementations, a manner of displaying, in the sharing prompt region, the second virtual object currently possessed by the second account may include, but is not limited to, at least one of the following: displaying an object name of the second virtual object in a text form in the sharing prompt region; or displaying an object identifier of the second virtual object in a graphic form in the sharing prompt region. In some embodiments, object information of the second virtual object may further be displayed in the sharing prompt region. The object information may include, but is not limited to, level information of the second virtual object and type information of the second virtual object (for example, a type of the second virtual object, such as a “warrior” or an “assassin”).

When the second virtual object is displayed in the sharing prompt region, the first account may learn of related information about the virtual object currently possessed by the second account, to assist in determining whether the current second account needs the to-be-shared target virtual object, thereby improving the communication efficiency during virtual object sharing.

Finally, the second interaction operation in the foregoing operation S206 may be a confirmation operation, namely, an operation of determining to transfer a possessing right of the target virtual object possessed by the first account to the second account, corresponding to the first interaction operation. After receiving the second interaction operation, the electronic device cancels displaying of the target virtual object in the first object display region located on the current interaction interface of the first account, and transmits the object sharing information to the second account via a server. The server parses the object sharing information transmitted by the first account; then updates an originally recorded ownership status of the target virtual object based on a parsing result, that is, changes an owning party of the target virtual object from the first account to the second account; and transmits the object sharing information to a terminal to which the second account logs in. After receiving the object sharing information, the terminal of the second account displays the target virtual object in a second object display region on a current interaction interface of the second account, to indicate that the second account has currently possessed the target virtual object.

In the foregoing implementations of this disclosure, in the process in which the first account shares a virtual object with the second account, a virtual object that has been currently possessed by the second account, namely, a teammate account, may be displayed on an interface in response to the first interaction operation, to assist the first account in determining whether the second account needs the currently selected target virtual object. In this way, a possessing status of the virtual object of the second account can be quickly learned of without initiating voice communication or transmitting text information to the second account, so that communication efficiency between the different accounts in the virtual object sharing process is improved. That is, communication efficiency in the virtual object sharing process is improved.

In some embodiments, the displaying, in the sharing prompt region, a second virtual object currently possessed by a second account includes the following operations:

S1. Determine, in the second object display region on the current interaction interface of the second account, the second virtual object currently possessed by the second account.

S2. Display the second virtual object in the sharing prompt region.

In the foregoing implementation of this disclosure, a manner of displaying the second virtual object may be determining, based on a virtual object in the second object display region on the current interaction interface of the second account, a virtual object that needs to be displayed in the sharing prompt region on the current interaction interface of the first account. In other words, the foregoing implementation of this disclosure may be performing a recurrence operation on the second object display region in the sharing prompt region, thereby visually displaying the second virtual object currently possessed by the second account.

In some embodiments, the determining, in the second object display region, the second virtual object currently possessed by the second account may be: first directly obtaining the current interaction interface of the second account from the server, performing a clipping operation on the second object display region on the obtained current interaction interface of the second account, and then directly displaying the clipped second object display region in the sharing prompt region; or in some other implementations, may be obtaining region description information of the second object display region on the current interaction interface of the second account from the server, and then re-rendering the second virtual object in the sharing prompt region on an application interface of the first account based on the region description information. The region description information herein may include the object information of the second virtual object, for example, information that can uniquely represent the virtual object, such as the object name or an object number, or a level of the second virtual object, and may further include a display location of the second virtual object in the second object display region.

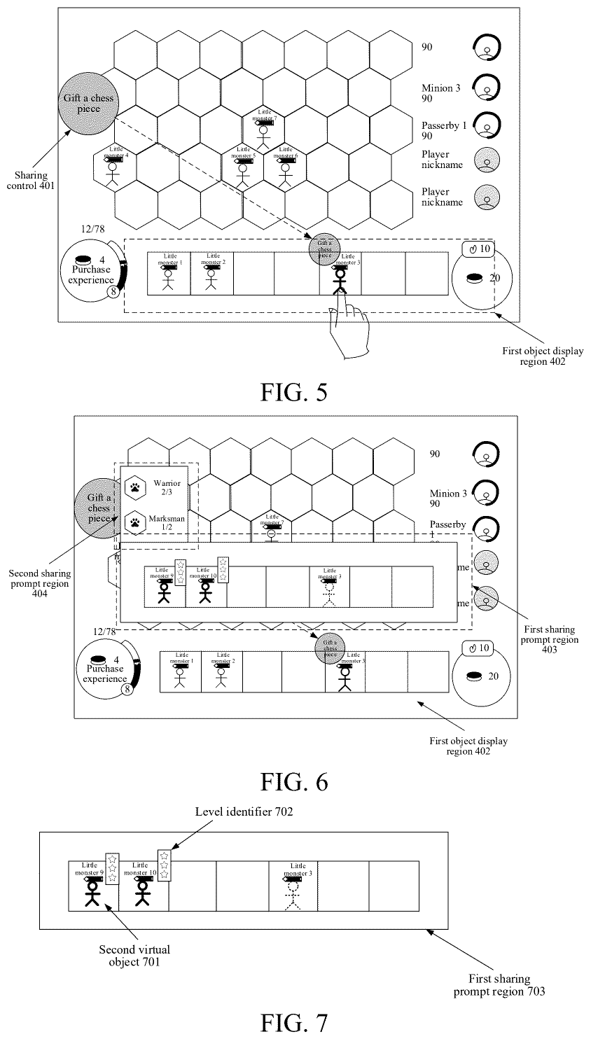

The foregoing implementation is described in detail below with reference to FIG. 4 and FIG. 5.

As shown in FIG. 4, in this implementation, a sharing control 401 is provided to perform the foregoing object sharing operation. A first object display region 402 is displayed on the current interaction interface of the first account. First virtual objects currently possessed by the first account are displayed in the first object display region 402, and include “Little monster 1”, “Little monster 2”, and “Little monster 3”. In this implementation, in response to a trigger operation on the sharing control 401, the sharing control 401 may be adjusted to be in a highlighted state, indicating that the virtual object sharing process has currently been entered.

Next, as shown in FIG. 5, in response to dragging an icon of the sharing control 401 to a location of an icon of the target virtual object “Little monster 3”, the icon of the target virtual object “Little monster 3” is switched to be displayed in a highlighted state (displayed in a bold state in FIG. 5). Further, the current interaction interface of the first account may be shown in FIG. 6. A first sharing prompt region 403 and a second sharing prompt region 404 are displayed on the current interaction interface. In addition, second virtual objects such as “Little monster 9” and “Little monster 10” possessed by the second account are displayed in the first sharing prompt region 403. The sharing prompt region in the foregoing implementation may include the first sharing prompt region 403 and the second sharing prompt region 404 in FIG. 6.

In the foregoing implementation, the first interaction operation in operation S204 may be long-pressing the sharing control 401 on the current interaction interface shown in FIG. 4, and dragging the sharing control 401 to the icon of the target virtual object “Little monster 3”. In some implementations, manners of highlighting the selected target virtual object “Little monster 3” in FIG. 5 and presenting the first sharing prompt region and the second sharing prompt region in FIG. 6 may be simultaneously performed on the current interaction interface. In this implementation, the sharing prompt region in the foregoing operation S204 may include the first sharing prompt region 403 and the second sharing prompt region 404 in FIG. 6.

Through the foregoing implementation of this disclosure, the second virtual object currently possessed by the second account is determined in the second object display region on the current interaction interface of the second account, and the second virtual object possessed by the second account recurs in the sharing prompt region, so that the second virtual object currently possessed by the second account can be visually displayed, thereby facilitating the first account to determine whether the currently selected target virtual object is a virtual object needed by the second account, and further improving the communication efficiency during virtual object sharing.

In some implementations, after the displaying the second virtual object in the sharing prompt region, the virtual object sharing method provided in this embodiment of this disclosure may further include the following processing: synchronously displaying, in the sharing prompt region, a change of the second virtual object in the second object display region. In one example, the display of the second virtual object in the sharing prompt region is updated based on a change of the second virtual object in the second object display region. In one or more examples in this disclosure, “synchronously” correspond to a time difference of the same graphical information (for example, the change of the second virtual object) displayed in the second object display region and in the sharing prompt region is less than a time threshold, such as 200 milliseconds (ms).

In a game process, the second virtual object possessed by the second account may change, for example, a quantity of second virtual objects changes, the level of the second virtual object changes, and a virtual prop carried by the second virtual object changes. These changes may occur in response to an operation of the second account. The first account comprehensively determines, with reference to a real-time status of the second account, whether the second account still needs the target virtual object. In this way, in this embodiment of this disclosure, the change of the second virtual object may be synchronously displayed in the sharing prompt region on the current interaction interface of the first account, so that the first account can learn of the change of the second virtual object in real time, thereby further improving the communication efficiency in the virtual object sharing process.

The synchronously displaying, in the sharing prompt region, a change of the second virtual object in the second object display region includes at least one of the following:

Manner 1: Displaying of the second virtual object is correspondingly canceled in the sharing prompt region when the second virtual object in the second object display region is controlled to move to an object interaction region, the object interaction region being a region that is on the current interaction interface of the second account and that is configured for performing the virtual interaction operation. In one example, the display of the second virtual object in the sharing prompt region is stopped when the current interaction interface operated by the second account indicates moving the second virtual object displayed in the second object display region to displayed in an object interaction region on the current interaction interface, where the second one or more virtual interaction operations are performed when the second virtual object is displayed in the object interaction region.

Manner 2: Displaying of a level identifier of the second virtual object is correspondingly adjusted in the sharing prompt region when the level of the second virtual object in the second object display region is adjusted.

Manner 3: Displaying of the display location of the second virtual object is updated in the sharing prompt region when the second virtual object in the second object display region moves from a first display location to a second display location.

In this implementation, the auto battler-type game application is used as an example. The foregoing manner 1 may be a virtual object field entering operation performed by the second account, namely, an operation of moving the second virtual object in the second object display region (the battle preparation region) to the object interaction region (the battle region), to adjust the second virtual object to an active state, for example, an automatic battling state. When the second virtual object is controlled to move to the object interaction region on the current interaction interface of the second account, an object status of the second virtual object is switched to the active state. In a process of the manner 1, the quantity of second virtual objects in the second object display region decreases, and a change of the quantity of second virtual objects is synchronously displayed in an object sharing region of the first account, so that the first account determines whether to share the target virtual object with the second account.

The auto battler-type game application is used as an example. The foregoing manner 2 may be that the level of the second virtual object in the second object display region (the battle preparation region) changes after the second account performs a related operation. In this implementation, the change of the level of the second virtual object may be synchronously displayed in the sharing prompt region of the first account. For example, the level identifier of the second virtual object is updated. Adjustment of the level of the second virtual object may be triggered by merging second virtual objects of the same type. In this case, a quantity of the second virtual objects of the same type decreases. In this way, this process may be understood as a process of merging two or more same second virtual objects into one second virtual object (for example, in the auto battler-type game application, two same chess pieces are dragged and merged into one chess piece of a higher level).

The auto battler-type game application is used as an example. The foregoing manner 3 may be an operation of adjusting, by the second account, a location of a virtual object in auto battler, that is, adjusting the location of the second virtual object in the second object display region (the battle preparation region), to synchronously display a change of the object location of the second virtual object in the sharing prompt region of the first account.

According to the foregoing implementation of this disclosure, a change status in the second object display region on the current interaction interface of the second account may be presented in the sharing prompt region, and alignment (changing the location of the virtual object), starring up (increasing the level of the virtual object), and the field entering operation (changing the status of the virtual object and changing the quantity of virtual objects) performed by the second account on the second virtual object possessed by the second account may be synchronously displayed in the sharing prompt region, thereby facilitating the first account to determine a current operation policy of the second account, to share the virtual object in cooperation with the current operation policy of the second account. Finally, the communication efficiency during virtual object sharing is improved.

In some implementations, after the determining, in the second object display region on the current interaction interface of the second account, the second virtual object currently possessed by the second account, the virtual object sharing method provided in this embodiment of this disclosure further includes the following operations:

S1. Generate sharing prompt information based on an object association relationship between the second virtual object and the target virtual object, the object association relationship being determined based on respective object attributes of the second virtual object and the target virtual object, and the sharing prompt information being configured for indicating a virtual gain effect provided by the target virtual object when the second account possesses the target virtual object.

S2. Display the sharing prompt information and the second virtual object in the sharing prompt region.

In the foregoing implementation of this disclosure, in the process in which the first account shares the virtual object, the object association relationship between the shared target virtual object and the second virtual object possessed by the second account may be considered, to determine the corresponding virtual gain effect, so that the sharing prompt information configured for identifying the virtual gain effect can be displayed in the sharing prompt region. In this way, the first account can learn of which benefits can be brought to the second account by sharing the target virtual object with the second account, thereby facilitating the first account to determine.

The foregoing object association relationship may be an object cooperation relationship (two virtual objects may cooperate to generate a better interaction effect), or may be an object refraining relationship (two virtual objects mutually refrain, which makes cooperation difficult). For different types of object association relationships, different gain effects may be provided.

The gain effect may include, but is not limited to, improving the level of the second virtual object, adding a virtual skill to the second virtual object, improving attribute data of the second virtual object, or the like.

In some embodiments, determining the object association relationship based on the respective object attributes of the second virtual object and the target virtual object may be implemented by using the following processing: performing relationship searching in a predefined association rule (the rule is usually set at a game development phase) based on the object attribute of the second virtual object and the object attribute of the target virtual object, to determine the relationship between the second virtual object and the target virtual object, for example, whether there is a cooperation or refraining relationship, or whether the second virtual object and the target virtual object belong to the same object type (for example, whether both belong to a “marksman” type).

In some embodiments, the generating sharing prompt information based on an object association relationship between the second virtual object and the target virtual object may be implemented by using the following processing: determining, based on the object association relationship, the virtual gain effect provided by the target virtual object; and generating the matched sharing prompt information for the virtual gain effect.

Herein, a type of the virtual gain effect, for example, an attacking power gain, a defense power gain, or a level increase, may be first determined based on a specific property of the object association relationship. Then, a specific gain value is calculated with reference to a calculation rule corresponding to the type of the gain effect. For example, the specific gain value such as a level that can be increased is calculated based on a degree (for example, 20% or 40%) of cooperation between the target virtual object and the second virtual object and a predefined calculation rule or calculation formula.

The auto battler-type game application is used as an example. When the object association relationship represents that the target virtual object and the second virtual object are the same, the type of the virtual gain effect may be increasing the level of the virtual object, so that a level increasing amplitude (for example, increasing by one level or increasing by two levels) that the target virtual object can bring to the second virtual object is determined based on a level of the target virtual object and the level of the second virtual object, to obtain the virtual gain effect. When the object association relationship represents that the target virtual object and the second virtual object are different, the type of the virtual gain effect may be increasing an object interworking gain of the virtual object. Then, an interworking gain value that can be brought may be determined based on contribution of the target virtual object to the object interworking gain and contribution of the second virtual object to the object interworking gain, to obtain the virtual gain effect.

A manner of displaying the sharing prompt information in the sharing prompt region may be prompting in a text form, or may be prompting in an image display form.

In some implementations, the displaying the sharing prompt information and the second virtual object in the sharing prompt region includes:

Manner 1: The second virtual object and a level identifier corresponding to an increased level of the second virtual object are highlighted in the sharing prompt region when the virtual gain effect is increasing the object level of the second virtual object.

Manner 2: When the virtual gain effect is increasing the object interworking gain of the second virtual object, the second virtual object and the object interworking gain are displayed in the sharing prompt region, the object interworking gain being a gain effective for the second virtual object of the same type. In one example, the object interworking gain indicates an effect on one or more other virtual objects that are of a same type of the second virtual object.

In the foregoing manner 1, when the target virtual object is transferred to the second account for possessing so that the level of the second virtual object that has been possessed by the second account is increased, the related second virtual object and a latest level identifier of the second virtual object may be highlighted in the sharing prompt region, so that a level increase status that can be brought by the target virtual object is more conspicuous. In the foregoing manner 2, when the target virtual object is transferred to the second account for possessing so that the object interworking gain may be added to the second virtual object that has been possessed by the second account, the object interworking gain and the second virtual object may both be displayed in the sharing prompt region. The second virtual object may be displayed in the first sharing prompt region, and identification information of the object interworking gain is displayed in the second sharing prompt region.

The object interworking gain may be a virtual synergy gain, and the virtual synergy gain may act on the second virtual object having the same object type as the virtual synergy gain in the second virtual objects possessed by the second account. For example, when the virtual synergy gain is “armor improvement”, armor improvement may be simultaneously performed for a second virtual object that is of a “warrior” type and that is possessed by the second account. For another example, when the virtual synergy gain is “damage value increase”, a damage value may be simultaneously increased for a second virtual object that is of an “assassin” type and that is possessed by the second account.

Implementation of the foregoing virtual synergy gain may take effect when a configuration condition thereof is satisfied. The configuration condition may be that a particular quantity of virtual objects of a particular type is reached. For example, triggering of the virtual synergy gain “armor improvement” may be that an object quantity of second virtual objects that are of the “warrior” type and that are possessed by the second account is greater than or equal to 3. A configuration condition of the virtual synergy gain “damage value increase” may be that an object quantity of second virtual objects that are of the “assassin” type and that are possessed by the second account is greater than or equal to 2.

The foregoing implementation is described below with reference to FIG. 7. As shown in FIG. 7, when the target virtual object selected by the first account is “Little monster 3”, the second virtual objects “Little monster 9” and “Little monster 10” currently possessed by the second account, and the target virtual object “Little monster 3” may be synchronously displayed in a first sharing prompt region 703.

When the target virtual object “Little monster 3” may enable object levels of the second virtual objects “Little monster 9” and “Little monster 10” to be increased from a level 2 to a level 3, as shown in FIG. 7, an object identifier of “Little monster 9”, namely, a second virtual object 701, is highlighted (likewise, an object identifier of “Little monster 10” is highlighted). A specific highlighting manner may be highlighting or bold display. The specific highlighting manner is not limited herein. In addition, a level identifier 702 corresponding to an increased level is further highlighted, to indicate to the first account that the target virtual object “Little monster 3” may enable the level of the virtual object possessed by the second account to be increased.

According to the foregoing implementation of this disclosure, the second virtual object and the latest level identifier of the second virtual object are highlighted in the sharing prompt region when the virtual gain effect is increasing the object level of the second virtual object, thereby facilitating the first account to determine the current operation policy of the second account, to share the virtual object in cooperation with the current operation policy of the second account, and improve the communication efficiency during virtual object sharing.

In some implementations, the displaying the second virtual object and the object interworking gain in the sharing prompt region includes the following operations:

S1. Display the second virtual object in the sharing prompt region. A sliding list is displayed in the sharing prompt region, where the sliding list indicates a subset of an object interworking gain list at a time. The object interworking gain list includes one or more recorded object interworking gains of one or more combinations of the second virtual object and respective one or more virtual objects.

S2. Based on a target object interworking gain of possessing the second virtual object and the target virtual object being included in the object interworking gain list, the display of the sliding list is updated with a sliding effect such that the sliding list indicates at least the target object interworking gain, and configuration progress information of the target object interworking gain is updated. Based on the target object interworking gain being not included in the object interworking gain list, the target object interworking gain is added to the object interworking gain list, and configuration progress information of the target object interworking gain is added.

In the foregoing implementation of this disclosure, there may be a second virtual object that can trigger object interworking gains in the second virtual objects possessed by the second account, so that these triggered object interworking gains are existing object interworking gains of the second virtual object. The existing object interworking gain of the second virtual object may be an object interworking gain that has been configured (a configuration condition has been completely achieved, for example, a particular quantity of virtual objects of a particular type is reached), or may be an object interworking gain that is in a configuration process (a configuration condition has been triggered but is not completely achieved, for example, there has been a virtual object of a particular type, but a particular quantity of virtual objects of the particular type has not been reached). The existing object interworking gain of the second virtual object may be presented by using the object interworking gain list. Next, whether the target object interworking gain corresponding to the target virtual object exists in the existing object interworking gain of the second virtual object may be determined, and whether to automatically slide the object interworking gain list to display the target object interworking gain or to newly add the target object interworking gain to the object interworking gain list is determined based on a determining result. In this way, when the first sharing prompt region that is in the sharing prompt region and that is configured for displaying the foregoing object interworking gain is relatively limited, the target object interworking gain corresponding to the target virtual object may be preferentially presented. For example, when the object interworking gain list is displayed in the sharing prompt region, the object interworking gain list may be automatically slid to display the target object interworking gain corresponding to the target virtual object.

In the foregoing implementation of this disclosure, when the target object interworking gain is in a configuration process, the configuration progress information of the target object interworking gain is further displayed in the sharing prompt region. The configuration progress information is configured for describing a current configuration progress of the target object interworking gain, for example, a quantity that is of virtual objects of a particular type and that has been reached. In this way, an amount of information that can be learned of by the first account can be learned of, thereby helping improve the communication efficiency during virtual object sharing.

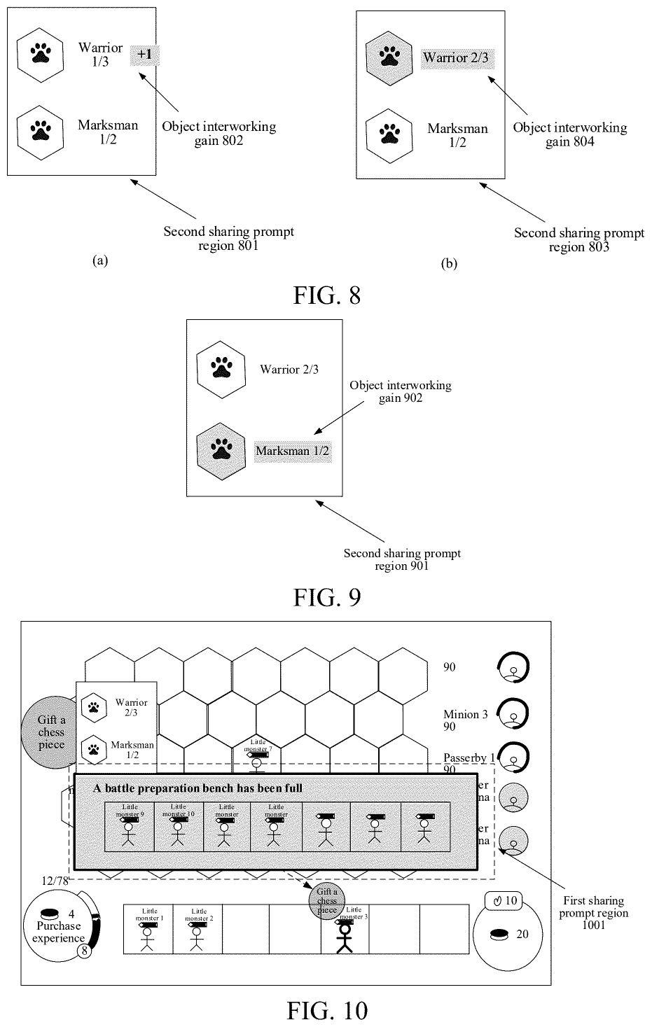

The following further provides descriptions with reference to FIG. 8. As shown in (a) in FIG. 8, when the target virtual object selected by the first account is “Little monster 3”, an object interworking gain 802 corresponding to the second virtual object possessed by the second account may be synchronously displayed in a second sharing prompt region 801. For example, the object interworking gain 802 is “Warrior 1/3”, indicating that three virtual objects of a warrior type need to be combined to obtain a virtual synergy gain “warrior”. However, the second account currently possesses only one virtual object of the warrior type. That is, configuration progress information of the virtual synergy gain “warrior” obtained by combining the second virtual objects possessed by the current second account is “1/3”. That is, two more virtual objects of the warrior type are needed.

In this case, the target virtual object “Little monster 3” currently selected by the first account is the virtual object of the warrior type, and sharing prompt information “+1” is highlighted in the second sharing prompt region 801, to indicate that the target virtual object “Little monster 3” may accelerate the configuration progress information of combination of the virtual synergy gain “warrior” to “2/3”.

In another display manner, as shown in (b) in FIG. 8, an object interworking gain 804 “Warrior 2/3” may be highlighted in a second sharing prompt region 803, to indicate that the target virtual object “Little monster 3” may accelerate the configuration progress information of combination of the virtual synergy gain “warrior” to “2/3”.

In some embodiments, assuming that there is no virtual synergy gain “marksman” in a combination of the second virtual objects currently possessed by the second account, and the target virtual object “Little monster 3” currently selected by the first account is a virtual object that can trigger generation of the virtual synergy gain “marksman”, an object interworking gain 902 “Marksman 1/3” in the foregoing region is highlighted in a second sharing prompt region 901 shown in FIG. 9, to indicate that the target virtual object “Little monster 3” may add a new virtual synergy gain to the second virtual object.

According to the foregoing implementation of this disclosure, when the virtual gain effect is increasing the object interworking gain of the second virtual object, the object interworking gain and the configuration progress information of the object interworking gain are displayed in the sharing prompt region, thereby facilitating the first account to determine the current operation policy of the second account, to share the virtual object in cooperation with the current operation policy of the second account, and improve the communication efficiency in the virtual object sharing process.

In some implementations, during the displaying a sharing prompt region in response to a first interaction operation on a target virtual object in the at least one first virtual object, the virtual object sharing method provided in this embodiment of this disclosure further includes:

Case 1: The target virtual object is displayed in a first style in the sharing prompt region when an object quantity of a set of virtual objects currently possessed by the second account is less than a quantity threshold, the target virtual object in the first style indicating that the second account is allowed to receive the target virtual object.

Case 2: The sharing prompt information is displayed in a second style in the sharing prompt region when an object quantity of the set of virtual objects currently possessed by the second account is greater than or equal to a quantity threshold, the sharing prompt information in the second style indicating that the second account is not allowed to receive the target virtual object.

The foregoing two cases are described below with reference to FIG. 6 and FIG. 10. As shown in FIG. 6, a redundant object display location is displayed in the second object display region displayed in the first sharing prompt region 403. This indicates that the object quantity of second virtual objects currently possessed by the second account is 2, which is less than a quantity threshold 7. In this case, this indicates that the second account may receive the target virtual object, the target virtual object “Little monster 3” currently selected by the first account may be displayed in a virtual shadow (which is displayed in a dashed line style in FIG. 6) manner (that is, the first style) in the first sharing prompt region 403, and the currently selected target virtual object “Little monster 3” is highlighted (which is displayed in a bold style in FIG. 6) in the first object display region 402.

As shown in FIG. 10, when there is no redundant object display location in the second object display region displayed in a first sharing prompt region 1001. That is, there is a second virtual object at each object display location. That is, the object quantity of the second virtual objects currently possessed by the second account is equal to the quantity threshold 7, the second account cannot receive the target virtual object, sharing prompt information (in a bold style in FIG. 10) of “A battle preparation bench has been full” may be highlighted in the first sharing prompt region 1001, and brightness of the first sharing prompt region 1001 is reduced (in a grayscale display style in FIG. 10), to further highlight the sharing prompt information. In addition, the target virtual object “Little monster 3” in the first object display region of the first account is highlighted (displayed in a bold style in FIG. 10), to indicate that the currently selected target virtual object is “Little monster 3”.

According to the foregoing implementation of this disclosure, the target virtual object is displayed in the first style in the sharing prompt region when the object quantity of second virtual objects currently possessed by the second account is less than the quantity threshold; or the sharing prompt information is displayed in the second style in the sharing prompt region when the object quantity of second virtual objects currently possessed by the second account is greater than or equal to the quantity threshold, to prompt quickly whether the second account can currently receive the target virtual object, thereby improving the communication efficiency in the virtual object sharing process.

In some implementations, after the displaying the target virtual object in a first style in the sharing prompt region, the virtual object sharing method provided in this embodiment of this disclosure further includes:

Case 1: First interaction prompt information transmitted by the second account is displayed on the current interaction interface of the first account when the first interaction prompt information is received, the first interaction prompt information indicating that the second account agrees to receive the target virtual object.

Case 2: Second interaction prompt information transmitted by the second account is displayed on the current interaction interface of the first account when the second interaction prompt information is received, the second interaction prompt information indicating that the second account refuses to receive the target virtual object.

Case 3: When third interaction prompt information transmitted by the second account is received, a reference virtual object in the first object display region is highlighted based on the third interaction prompt information, the third interaction prompt information indicating a transfer request of the reference virtual object from the first account, and the reference virtual object being one of the at least one first virtual object other than the target virtual object.

In other words, when the second account agrees to receive or refuses to receive the target virtual object shared by the first account, the corresponding interaction prompt information is returned to the first account, so that the first account learns of a processing status of the second account for the target virtual object shared by the first account. In addition, in an operation process in which the first account shares the target virtual object, the second account may further actively request a virtual object from the first account. In this case, the virtual object requested by the second account is referred to as the reference virtual object, and the reference virtual object may be any first virtual object other than the target virtual object. This is not limited in this embodiment of this disclosure herein.

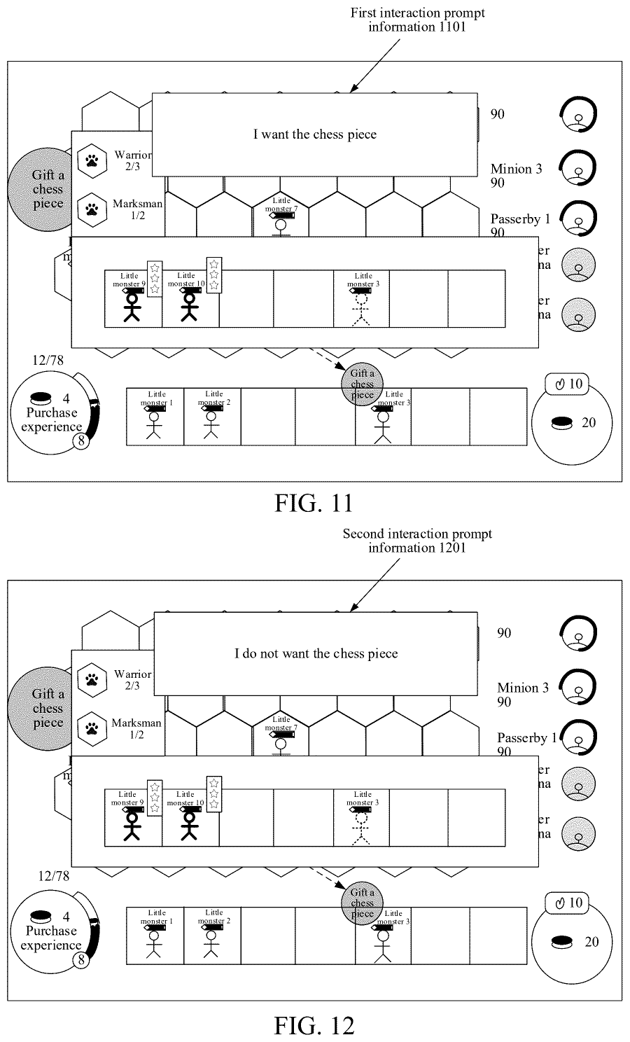

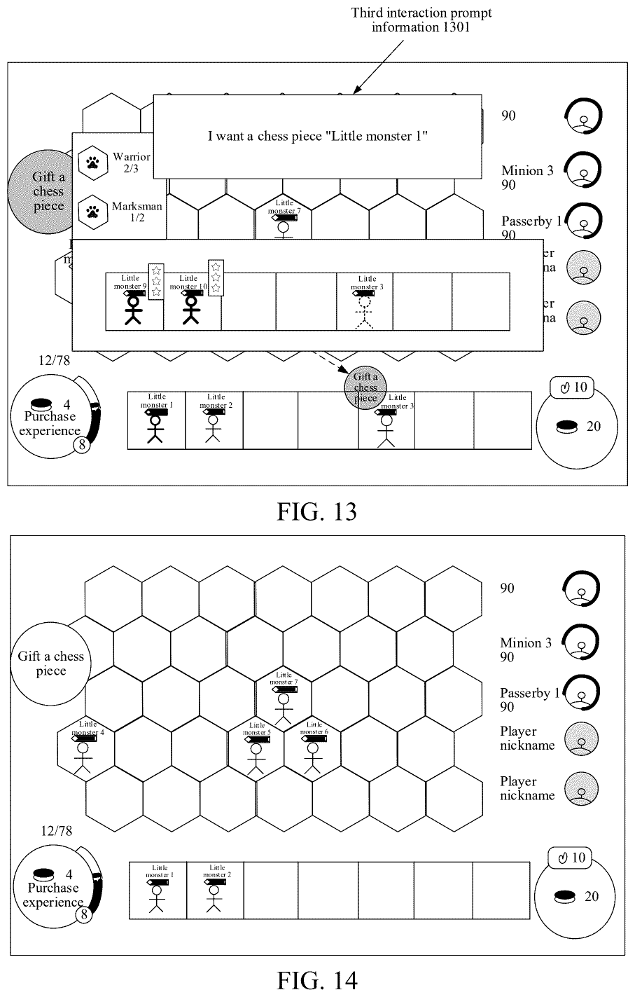

The foregoing three cases are described below with reference to FIG. 11, FIG. 12, and FIG. 13.

As shown in FIG. 11, after the target virtual object is displayed in the first style in the sharing prompt region, when first interaction prompt information 1101 transmitted by the second account is received, the first interaction prompt information 1101 may be displayed on the current interaction interface, to indicate that the second account agrees to receive the currently selected target virtual object. As shown in FIG. 12, after the target virtual object is displayed in the first style in the sharing prompt region, when second interaction prompt information 1201 transmitted by the second account is received, the second interaction prompt information 1201 may be displayed on the current interaction interface, to indicate that the second account refuses to receive the currently selected target virtual object. As shown in FIG. 13, after the target virtual object is displayed in the first style in the sharing prompt region, when third interaction prompt information 1301 transmitted by the second account is received, third interaction prompt information 1301 “I want a chess piece ‘Little monster 1” may be displayed on the current interface, to indicate that the second account does not accept the currently selected target virtual object Little monster 3, but wants the first virtual object “Little monster 1” currently possessed by the first account. In addition, the first virtual object “Little monster 1” wanted by the second account may be highlighted in the first object display region (displayed in a bold display style in FIG. 13).

In some implementations, after the displaying the target virtual object in a first style in the sharing prompt region, the virtual object sharing method provided in this embodiment of this disclosure further includes: performing one of the following processing when the first interaction operation is dragging an interaction operation identifier to the target display region corresponding to the target virtual object, the target display region being the display region that is in the first object display region and in which the target virtual object is located:

Case 1: Displaying of the target virtual object is canceled in the first object display region, and displaying of the sharing prompt region is canceled, in response to an operation of releasing the interaction operation identifier in the target display region. In one example, the display of the target virtual object in the first object display region is stopped, and the display of the sharing prompt region is stopped, based on an operation of releasing the interaction operation identifier in the target display region.

Case 2: Displaying the target virtual object is kept in the first object display region, and displaying of the sharing prompt region is canceled, in response to an operation of releasing the interaction operation identifier in a region outside the target display region. In one example, the display of the target virtual object in the first object display region is stopped, and the display the target virtual object in the first object display region is kept, based on to an operation of releasing the interaction operation identifier in a region outside the target display region.

In the foregoing implementation of this disclosure, the target display region is an object display location occupied by the target virtual object in the first object display region. When the interaction operation identifier is dragged to the target display region in which the target virtual object is located, and the interaction operation identifier is released in the target display region, the first account may determine to share the target virtual object with the second account, so that the target virtual object is removed from the first object display region, and the sharing prompt region is revoked.

As shown in FIG. 6 and FIG. 14, as shown in FIG. 6, in response to dragging the sharing control (namely, the interaction operation identifier) to the target virtual object “Little monster 3”, the first sharing prompt region 403 and the second sharing prompt region 404 are displayed. In response to the release operation of the dragging operation, it is determined to share the target virtual object “Little monster 3” with the second account. Further, interface display is shown in FIG. 14. Displaying of the target virtual object “Little monster 3”, the first sharing prompt region 403, and the second sharing prompt region 404 are canceled in the first object display region, to indicate that the second account has currently possessed the target virtual object “Little monster 3”.

In the second case, to be specific, an operating point of the release operation corresponding to the dragging operation is not located in the target display region in which the target virtual object is located, it may be determined that the first account does not currently want to transfer the target virtual object to the second account for possessing, to cancel sharing of the target virtual object with the second account, displaying the target virtual object is kept in the first object display region, and the sharing prompt region is revoked.

In some implementations, after the highlighting a reference virtual object in the first object display region, the method includes: performing the following processing when the first interaction operation is dragging an interaction operation identifier to the target display region:

S1. Display the reference virtual object in the first style in the sharing prompt region in response to adjusting a drag end point of a dragging operation to a reference display region, the reference display region being a region that is in the first object display region and in which the reference virtual object is located. In one example, the reference virtual object is displayed in the first style in the sharing prompt region based on a drag end point of a dragging operation of the interaction operation identifier falling within a reference display region, the reference display region being a region in the first object display region and in which the reference virtual object is displayed.

S2. Cancel displaying of the reference virtual object in the first object display region, and cancel displaying of the sharing prompt region, in response to a release operation in the reference display region. In one example, display of the reference virtual object in the first object display region is stopped and the display of the sharing prompt region is stopped based on a release operation of the dragging operation when the drag end point is in the reference display region

In the foregoing implementation, when the third interaction prompt information transmitted by the second account is received, the operation end point of the dragging operation may be moved to the reference display region corresponding to the reference virtual object, to select the reference virtual object requested by the second account, and displaying of the reference virtual object is updated in the first style in the sharing prompt region. Finally, in response to the release operation whose operating point is located in the reference display region, it may be determined to share the reference virtual object with the second account, and displaying of the reference virtual object is canceled in the object display region.

In some implementations, before the displaying a sharing prompt region in response to a first interaction operation on a target virtual object in the at least one first virtual object, the virtual object sharing method provided in this embodiment of this disclosure further includes:

Case 1: When there are a plurality of teammate accounts in the same interaction camp as the first account, the plurality of teammate accounts are determined as a plurality of second accounts in response to a third interaction operation. In one example, prior to the displaying a sharing prompt region and when a plurality of teammate accounts is included in the same interaction camp as the first account, two or more teammate accounts of the plurality of teammate accounts are determined as selected receiving accounts based on a third interaction operation, the two or more teammate accounts including the second account and one or more additional second accounts.

In this case, the displaying a sharing prompt region in response to a first interaction operation on a target virtual object in the at least one first virtual object includes: displaying, in response to the first interaction operation on the target virtual object, a plurality of sharing prompt regions respectively corresponding to the plurality of second accounts.

Case 2: When there are a plurality of teammate accounts in the same interaction camp as the first account, the second account is determined in the plurality of teammate accounts in response to a fourth interaction operation. In one example, prior to the displaying a sharing prompt region and when a plurality of teammate accounts is included in the same interaction camp as the first account, the second account in the plurality of teammate accounts are determined based on a fourth interaction operation.

Then, the sharing prompt region corresponding to the second account may be displayed in response to the first interaction operation on the target virtual object. That is, only one sharing prompt region is displayed.

In the foregoing implementation, two interaction manners are provided. An interaction manner corresponding to the third interaction operation is: selecting all teammate accounts of the first account, and respectively displaying the plurality of sharing prompt regions based on second object display regions of all the teammate accounts, thereby facilitating the first account to evaluate different gain effects that can be brought by sharing the target virtual object with different teammates, to quickly make a correct sharing decision. An interaction manner corresponding to the fourth interaction operation is selecting the second account from the plurality of teammate accounts, to accurately select an account with which the target virtual object is to be shared.

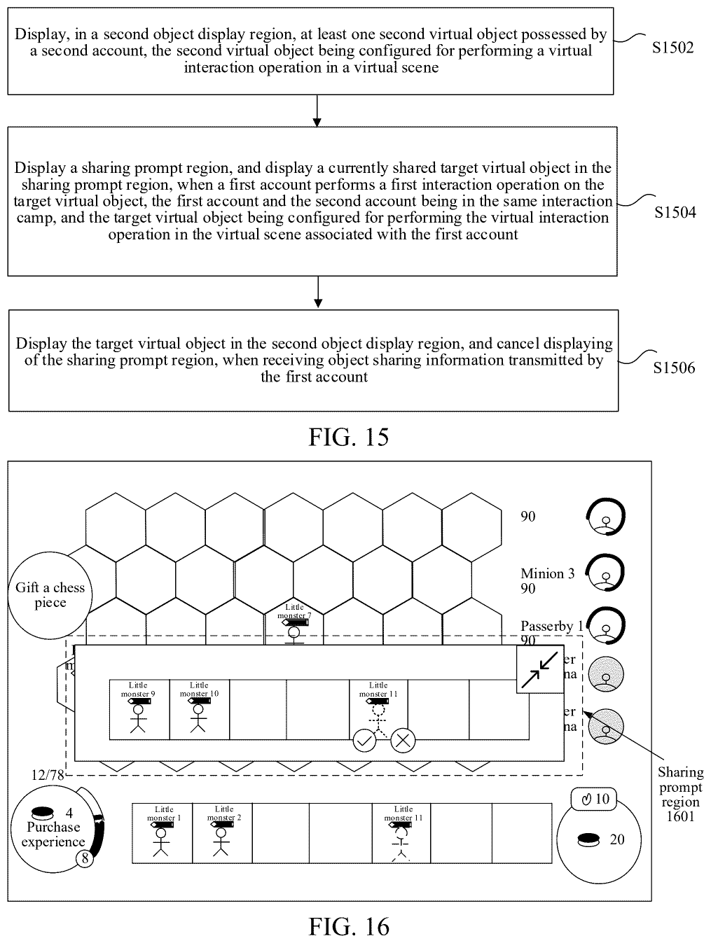

In some implementations, as shown in FIG. 15, this disclosure further provides a virtual object obtaining method, applied to a client to which a second account logs in, and including the following operations:

S1502. Display, in a second object display region, at least one second virtual object possessed by the second account, the second virtual object being configured for performing a virtual interaction operation in a virtual scene. In one example, at least one second virtual object possessed by a second account is displayed in a second object display region. The second virtual object is configured to perform second one or more virtual interaction operations in a virtual environment.

S1504. Display a sharing prompt region, and display a currently shared target virtual object in the sharing prompt region, when a first account performs a first interaction operation on the target virtual object, the first account and the second account being in the same interaction camp, and the target virtual object being configured for performing the virtual interaction operation in the virtual scene associated with the first account. In one example, a sharing prompt region and, in the sharing prompt region, a target virtual object possessed by a first account are displayed. The target virtual object is configured to perform first one or more virtual interaction operations in the virtual scene.

S1506. Display the target virtual object in the second object display region, and cancel displaying of the sharing prompt region, when receiving object sharing information transmitted by the first account. In one example, when object sharing information associated with the first account is received, the target virtual object is displayed in the second object display region, and the display of the sharing prompt region is stopped.

In some implementations, the displaying a target virtual object in the sharing prompt region includes the following operations:

S1. Determine, in a first object display region on a current interaction interface of the first account, a first virtual object currently possessed by the first account, the first virtual object including the target virtual object.

S2. Display the first virtual object in the sharing prompt region.

The client of the second account may obtain, from a server, related information of the first object display region on the current interaction interface of the first account, for example, an image of the first object display region or a data packet corresponding to the first object display region (the data packet includes identification information of the first virtual object displayed in the first object display region and a display location of the first virtual object), and may determine, based on the obtained related information, the first virtual object possessed by the first account. For example, virtual object identification is performed on the image of the first object display region, to obtain the first virtual object; or the data packet of the first object display region is directly read, and the first virtual object is determined based on the identification information that is of the first virtual object and that is read from the data packet. After the first virtual object is determined, the first virtual object possessed by the first account may be displayed in the sharing prompt region. In this way, when the first account prepares to share the selected target virtual object with the second account, the first object display region of the first account may be synchronously displayed on a current interaction interface of the second account, so that the second account can learn of a current operation policy of the first account, to improve communication efficiency in a virtual object sharing process.

For a manner of displaying the first virtual object in the sharing prompt region on the current interaction interface of the second account, refer to the foregoing method embodiments. Details are not described herein again. The manner of displaying the first virtual object in the sharing prompt region on the current interaction interface of the second account may be the same as or different from a manner of displaying the second virtual object of the second account in the sharing prompt region on the current interaction interface of the first account. In this implementation, the foregoing display manner is not limited.

In some implementations, after the displaying a target virtual object in the sharing prompt region, the virtual object obtaining method provided in this embodiment of this disclosure further includes one of the following processing:

Manner 1: First interaction prompt information is transmitted to the first account in response to performing the first interaction operation on the target virtual object, the first interaction prompt information indicating that the second account agrees to receive the target virtual object.

Manner 2: Second interaction prompt information is transmitted to the first account in response to performing a second interaction operation on the target virtual object, the second interaction prompt information indicating that the second account refuses to receive the target virtual object.

Manner 3: Third interaction prompt information is transmitted to the first account in response to performing a third interaction operation on a reference virtual object, the third interaction prompt information (for example, indicating a transfer request of) being configured for obtaining the reference virtual object currently possessed by the first account, and the reference virtual object being a first virtual object other than the target virtual object.

The foregoing manner 1 may be an interaction operation for agreeing to receive the target virtual object currently shared by the first account. The foregoing manner 2 may be an interaction operation for refusing to receive the target virtual object currently shared by the first account. The foregoing manner 3 may be an interaction manner of refusing to receive the target virtual object currently shared by the first account and requesting another reference virtual object from the first account. For example, an operation form of the third interaction operation may be a long-press operation or a click operation on the reference virtual object in the sharing prompt region. A manner of selecting the reference virtual object from a plurality of first virtual objects is not limited herein.

In some implementations, after the displaying a target virtual object in the sharing prompt region, the virtual object obtaining method provided in this embodiment of this disclosure further includes at least one of the following processing:

Manner 1: A region display area of the sharing prompt region is adjusted, and displaying the target virtual object and operation controls corresponding to the target virtual object is kept in an adjusted sharing prompt region, in response to a first region adjustment operation, the operation controls including a first operation control configured for indicating that the target virtual object is agreed to be received and a second operation control configured for indicating that the target virtual object is refused to be received.

Manner 2: A region display location of the sharing prompt region is adjusted in response to a second region adjustment operation.

After the sharing prompt region is displayed on the current interaction interface of the second account, at least one of the region display area and the region display location of the sharing prompt region may be adjusted. When the region display area of the sharing prompt region is adjusted, displaying the target virtual object and the related operation controls may be kept, to facilitate determining whether to receive the target virtual object.

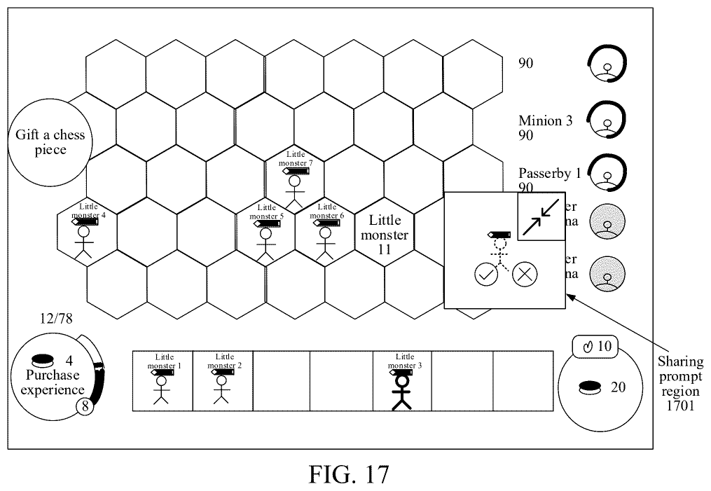

The foregoing implementation is described in detail below with reference to FIG. 16 and FIG. 17. As shown in FIG. 16, when the first account shares the selected target virtual object with the second account, on the current interaction interface of the second account, a status in the first object display region of the first account recurs by using a displayed sharing prompt region 1601. As shown in FIG. 16, a target virtual object “Little monster 11” selected by the first account may be highlighted (in a dashed line display style in FIG. 16), to indicate that the first account prepares to share “Little monster 11” with the second account.

Then, the second account may transmit receiving confirmation information “I want the chess piece” to the first account via a confirmation control displayed on “Little monster 11”; or the second account may transmit receiving refusing information “I do not want the chess piece” to the first account via a refusing control “X” displayed on “Little monster 11”; or in response to a long-press operation on a first virtual object “Little monster 9” displayed in the sharing prompt region 1601, may transmit an object obtaining request “I want a chess piece Little monster 9” to the first account.

In some implementations, gain effect information that can be provided by the target virtual object shared by the first account may further be displayed on the current interaction interface of the second account. For a manner of displaying the gain effect information on the current interaction interface of the second account, refer to the foregoing method embodiments. Details are not described herein again.

Further, in response to a trigger operation on a display area adjustment control displayed at an upper right corner of the sharing prompt region 1601 in FIG. 16, the interface may be switched to be displayed as shown in FIG. 17. A display area of a sharing prompt region 1701 is adjusted, and displaying the target virtual object and the operation controls corresponding to the target virtual object is kept in the sharing prompt region 1701.

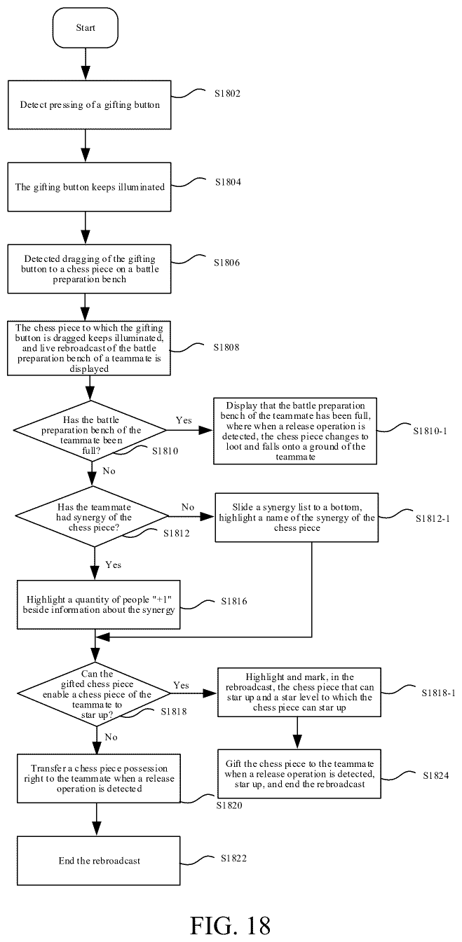

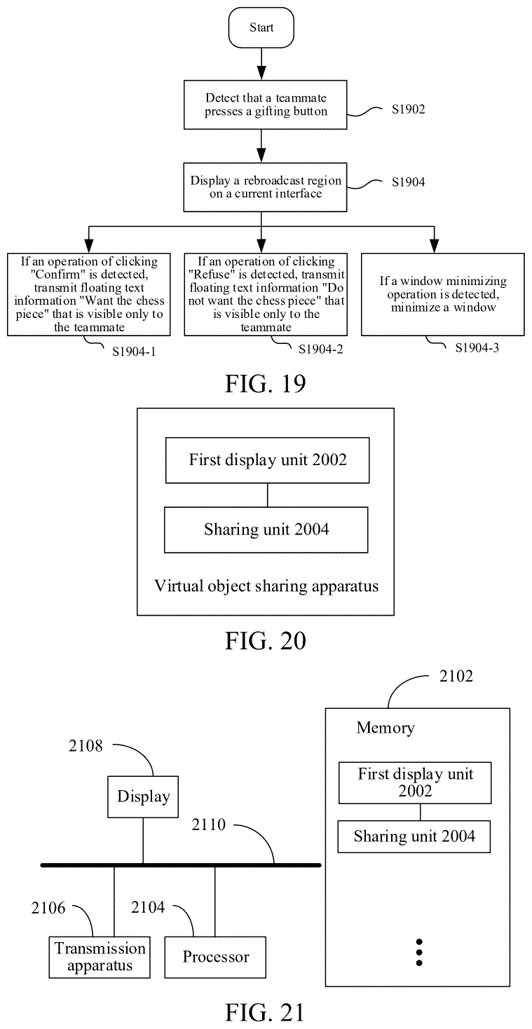

An implementation of this disclosure is described below with reference to FIG. 18 and FIG. 19. In this implementation, the foregoing virtual object is specifically a chess piece in an auto battler game, and an object display region is specifically an auto battler battle preparation bench.

Operations S1802 to S1808. Detect pressing of a gifting button (namely, an interaction operation identifier). The gifting button keeps illuminated. Detected dragging of the gifting button to a chess piece on a battle preparation bench. The chess piece (namely, a target virtual object) to which the gifting button is dragged keeps illuminated, and live rebroadcast of the battle preparation bench (a second object display region) of a teammate is displayed. All operations including chess piece discarding and starring up that the teammate is performing on the battle preparation bench need to be synchronized. Starring up herein may be implemented by merging virtual objects of the same type into the same virtual object, that is, changing a quantity of virtual objects, or may be implemented by using a specific virtual prop, for example, a starring up card.

Next, perform S1810. Determine whether the battle preparation bench of the teammate has been full. If yes, to be specific, the battle preparation bench has been full, perform S1810-1. Display that the battle preparation bench of the teammate has been full, where when a release operation is detected, the chess piece changes to loot and falls onto a ground of the teammate. Otherwise, perform determining of S1812. Determine whether the teammate has had synergy of the chess piece (namely, an object interworking gain).

Specifically, if the battle preparation bench has been full at this time, a disabled-and-full state (sharing prompt information in a second style) is displayed; and when the release operation is performed, the chess piece serves as the loot and falls onto the ground of the teammate. Otherwise, whether the teammate has had the synergy of the chess piece is determined.

If no, to be specific, when the teammate does not have the synergy of the chess piece, first perform S1812-1. Slide a synergy list (namely, an object interworking gain list) to a bottom, highlight a name of the synergy of the chess piece. Then, perform determining of S1818. Determine whether the gifted chess piece can make the teammate star up. If yes, first perform S1816. Highlight a quantity of people “+1” beside information about the synergy. Then, perform determining of S1818.

Specifically, if the teammate has had the synergy, the synergy list is displayed, automatically slides until a location of the synergy, and the tag+1 is highlighted. If the teammate has not had the synergy of the chess piece, a synergy preview pop-up window is displayed, and automatically slides to a bottom, and a new line is added to display the name of the synergy.

If a determining result of determining of S1818 is yes, to be specific, when the gifted chess piece can enable a chess piece of the teammate to star up (that is, increase an object level of a second virtual object is increased), perform S1818-1. Highlight and mark, in the rebroadcast, the chess piece that can star up and a star level to which the chess piece can star up (that is, a level identifier after the level is increased). S1824. Gift the chess piece to the teammate when a release operation (a second interaction operation) is detected, star up, and end the rebroadcast. If a determining result of determining of S1818 is no, perform S1820. Transfer a chess piece possession right to the teammate when a release operation is detected. S1822. End the rebroadcast.

Specifically, whether the gifted chess piece can enable the chess piece of the teammate to star up is determined first. If yes, in the rebroadcast, highlight reminding is performed on the chess piece that can star up and the star level to which the chess piece can star up. When the release operation is performed, the chess piece automatically merges to star up on the battle preparation bench of the teammate. If the chess piece of the teammate cannot star up, when the release operation is performed, the chess piece is gifted to the teammate, and is placed on the battle preparation bench.

Correspondingly, operations performed on an interaction interface of a second account may be shown in FIG. 19.

S1902. Detect that a teammate presses a gifting button. S1904. Display a rebroadcast region on a current interface (namely, a sharing prompt region on a current interaction interface of the second account).

Next, the second account may perform the following three operations: S1904-1. If an operation of clicking “Confirm” is detected, transmit floating text information “Want the chess piece” that is visible only to the teammate. S1904-2. If an operation of clicking “Refuse” is detected, transmit floating text information “Do not want the chess piece” that is visible only to the teammate. S1904-3. If a window minimizing operation is detected, minimize a window.

Specifically, whether the teammate drags the gifting button to a particular chess piece on a battle preparation bench is determined first. If yes, a teammate chessboard rebroadcast preview appears on a chessboard of the second account. As shown in FIG. 16, click a checkmark, to transmit, to the teammate, a prompt (first interaction prompt information) that is visible only to the teammate: I want the chess piece. In addition, an icon of the chess piece may be displayed simultaneously. Click a cross, to transmit, to the teammate, a prompt (second interaction prompt information) that is visible only to the teammate: I do not want the chess piece and an icon of the chess piece; and click “Minimize window”, so that rebroadcast can be minimized, and only a battle preparation bench slot in which the gifting button of the teammate is located is presented.

According to the foregoing implementations of this disclosure, in the interaction game disclosure, a visual mirror communication manner in which the player and the teammate perform a preparation operation on the battle preparation bench may be used. For a gifting party (the first account) initiating a sharing and gifting operation, when the gifting party gifts a chess piece, the chess to be gifted may be quickly compared with the battle preparation bench and a synergy list of the teammate, which is more visual and convenient. Help of chess piece gifting to the teammate can be quickly obtained through comparison, and information transmission efficiency is improved. For an accepting party (namely, the second account) receiving the chess piece, the accepting party can see a gifting operation process initiated by the gifting party without switching to a chessboard interface of the other party. This helps real-time communication, reduces operations, avoids mistaken decision of the gifting process, further improves the sharing communication efficiency, and resolves the technical problem of the relatively low communication efficiency in the existing virtual object sharing process.

For simple descriptions, the foregoing method embodiments are all stated as combinations of a series of actions. However, a person skilled in the art should understand that this disclosure is not limited to the sequence of the described actions because according to this disclosure, some steps may use another sequence or may be simultaneously performed. In addition, it is to also be appreciated by a person skilled in the art that embodiments described in this specification all belong to example embodiments, and the actions and the modules are not necessarily needed by this disclosure.

According to another aspect of embodiments of this disclosure, a virtual object sharing apparatus for implementing the foregoing virtual object sharing method is further provided. As shown in FIG. 20, the apparatus includes: a first display unit 2002, configured to: display, in a first object display region, at least one first virtual object possessed by a first account, the first virtual object being configured for performing a virtual interaction operation in a virtual scene; and display a sharing prompt region, and display, in the sharing prompt region, a second virtual object currently possessed by a second account, in response to a first interaction operation on a target virtual object in the at least one first virtual object, the second account and the first account being in the same interaction camp, and the second virtual object being configured for performing the virtual interaction operation in the virtual scene associated with the second account; and a sharing unit 2004, configured to: cancel displaying of the target virtual object in the first object display region, and transmit object sharing information to the second account, in response to a second interaction operation, the object sharing information being configured for transferring the target virtual object to the second account for possessing.

In the foregoing solution, the first display unit 2002 includes: an obtaining module, configured to determine, in a second object display region on a current interaction interface of the second account, the second virtual object currently possessed by the second account; and a display module, configured to display the second virtual object in the sharing prompt region.

In the foregoing solution, the first display unit 2002 is further configured to synchronously display, in the sharing prompt region, a change of the second virtual object in the second object display region.

In the foregoing solution, the first display unit 2002 is further configured to perform at least one of the following: correspondingly canceling displaying of the second virtual object in the sharing prompt region when the second virtual object in the second object display region is controlled to move to an object interaction region, the object interaction region being an interaction region that is on the current interaction interface of the second account and that is configured for performing the virtual interaction operation; correspondingly adjusting displaying of a level identifier of the second virtual object in the sharing prompt region when a level of the second virtual object in the second object display region is adjusted; or updating displaying of a display location of the second virtual object in the sharing prompt region when the second virtual object in the second object display region moves from a first display location to a second display location.

In the foregoing solution, the display module is further configured to: generate sharing prompt information based on an object association relationship between the second virtual object and the target virtual object, the object association relationship being determined based on respective object attributes of the second virtual object and the target virtual object, and the sharing prompt information being configured for indicating a virtual gain effect provided by the target virtual object when the second account possesses the target virtual object; and display the sharing prompt information and the second virtual object in the sharing prompt region.

In the foregoing solution, the display module is further configured to: highlight, in the sharing prompt region when the virtual gain effect is increasing the object level of the second virtual object, the second virtual object and a level identifier corresponding to an increased level of the second virtual object; or display, when the virtual gain effect is increasing an object interworking gain of the second virtual object, the second virtual object and the object interworking gain in the sharing prompt region, the object interworking gain being an object gain effective for the second virtual object of the same type.

In the foregoing solution, the display module is further configured to: display the second virtual object in the sharing prompt region, slide, to a target object interworking gain, an object interworking gain list that is in the sharing prompt region and that is configured for displaying the existing object interworking gain, and update configuration progress information of the target object interworking gain, when there is a target object interworking gain of the target virtual object in the existing object interworking gain of the second virtual object; or display the second virtual object in the sharing prompt region, and add a target object interworking gain and configuration progress information of the target object interworking gain to an object interworking gain list in the sharing prompt region, when there is no target object interworking gain in the existing object interworking gain of the second virtual object.

In the foregoing solution, the first display unit 2002 is further configured to: display the target virtual object in a first style in the sharing prompt region when an object quantity of second virtual objects currently possessed by the second account is less than a quantity threshold, the target virtual object in the first style indicating that the second account is allowed to receive the target virtual object; or display the sharing prompt information in a second style in the sharing prompt region when an object quantity of second virtual objects currently possessed by the second account is greater than or equal to a quantity threshold, the sharing prompt information in the second style indicating that the second account is not allowed to receive the target virtual object.

In the foregoing solution, the virtual object sharing apparatus further includes an interaction information prompt unit, configured to: display, when receiving first interaction prompt information transmitted by the second account, the first interaction prompt information on a current interaction interface of the first account, the first interaction prompt information indicating that the second account agrees to receive the target virtual object; display, when receiving second interaction prompt information transmitted by the second account, the second interaction prompt information on a current interaction interface of the first account, the second interaction prompt information indicating that the second account refuses to receive the target virtual object; or highlight, when receiving third interaction prompt information transmitted by the second account, a reference virtual object in the first object display region based on the third interaction prompt information, the third interaction prompt information indicating to request the reference virtual object from the first account, and the reference virtual object being a first virtual object other than the target virtual object.

In the foregoing solution, the first display unit 2002 is further configured to perform one of the following processing when the first interaction operation is dragging an interaction operation identifier to a target display region, the target display region being a display region that is in the first object display region and in which the target virtual object is located: canceling displaying of the target virtual object in the first object display region, and canceling displaying of the sharing prompt region, in response to an operation of releasing the interaction operation identifier in the target display region; or keeping displaying the target virtual object in the first object display region, and canceling displaying of the sharing prompt region, in response to an operation of releasing the interaction operation identifier in a region outside the target display region.

In the solution, the first display unit 2002 is further configured to perform the following processing when the first interaction operation is dragging an interaction operation identifier to a target display region: displaying the reference virtual object in the first style in the sharing prompt region in response to adjusting a drag end point of a dragging operation to a reference display region, the reference display region being a region that is in the first object display region and in which the reference virtual object is located; and canceling displaying of the reference virtual object in the first object display region, and canceling displaying of the sharing prompt region, in response to a release operation in the reference display region.

In the solution, the virtual object sharing apparatus further includes: an account determining unit, configured to determine, when there are a plurality of teammate accounts in the same interaction camp as the first account, the plurality of teammate accounts as a plurality of second accounts in response to a third interaction operation; and the first display unit 2002 is further configured to display, in response to the first interaction operation on the target virtual object, a plurality of sharing prompt regions respectively corresponding to the plurality of second accounts.

In the solution, the account determining unit is further configured to determine, when there are a plurality of teammate accounts in the same interaction camp as the first account, the second account in the plurality of teammate accounts in response to a fourth interaction operation.

In one or more embodiments, for embodiments to be implemented by the foregoing unit modules, refer to the foregoing method embodiments. Details are not described herein again.

According to an embodiment of this disclosure, an electronic device for implementing the foregoing virtual object sharing method is further provided. The electronic device may be a terminal device or a server shown in FIG. 21. In this embodiment, an example in which the electronic device is the terminal device is used for description. As shown in FIG. 21, the electronic device includes a memory 2102 and processing circuitry, such as a processor 2104. The memory 2102 has a computer program or computer-executable instructions stored therein. The processor 2104 is configured to implement operations in any one of the foregoing method embodiments when executing the computer program or the computer-executable instructions operations.

In some embodiments, the foregoing electronic device may be located in at least one of a plurality of network devices in a computer network.

In some embodiments, the foregoing processor may be configured to perform the following operations by using the computer program or the computer-executable instructions:

S1. Display, in a first object display region, at least one first virtual object possessed by a first account, the first virtual object being configured for performing a virtual interaction operation in a virtual scene.

S2. Display a sharing prompt region, and display, in the sharing prompt region, a second virtual object currently possessed by a second account, in response to a first interaction operation on a target virtual object in the at least one first virtual object, the second account and the first account being in the same interaction camp, and the second virtual object being configured for performing the virtual interaction operation in the virtual scene associated with the second account.

S3. Cancel displaying of the target virtual object in the first object display region, and transmit object sharing information to the second account, in response to a second interaction operation, the object sharing information being configured for transferring the target virtual object to the second account for possessing.

A person of ordinary skill in the art may understand that a structure shown in FIG. 21 is merely schematic. The electronic device may alternatively be a terminal device such as a smartphone, a tablet computer, a palmtop computer, a mobile Internet device (MID), or a pad. FIG. 21 does not constitute a limitation on a structure of the electronic device. For example, the electronic device may further include more or fewer components (for example, a network interface) than those shown in FIG. 21, or has a configuration different from that shown in FIG. 21.

The memory 2102 may be configured to store a software program and a module, such as a program instruction/module corresponding to the virtual object sharing method and apparatus in one or more embodiments of this disclosure. The processor 2104 executes the software program and the module stored in the memory 2102, to perform various function applications and data processing, that is, implement the foregoing virtual object sharing method. The memory 2102 may include a high speed random access memory, and may further include a non-volatile memory, such as one or more magnetic storage apparatuses, a flash memory, or another non-volatile solid state memory. In some instances, the memory 2102 may further include memories remotely disposed relative to the processor 2104. The remote memories may be connected to a terminal via a network. Instances of the network include, but are not limited to, the Internet, an Intranet, a local area network, a mobile communication network, and a combination thereof. The memory 2102 may be specifically, but is not limited to, configured to store information such as sharing information of various elements and virtual objects in a scene picture. In an example, as shown in FIG. 21, the memory 2102 may include, but is not limited to, the first display unit 2002 and the sharing unit 2004 in the foregoing virtual object sharing apparatus. Furthermore, the memory 2102 may further include, but is not limited to, another module unit in the virtual object sharing apparatus. Details are not described again in this example.

In some embodiments, a transmission apparatus 2106 is configured to receive or transmit data via a network. Specific instances of the foregoing network may include a wired network and a wireless network. In an instance, the transmission apparatus 2106 includes a network interface controller (NIC). The NIC may be connected to another network device and a router through a network cable, to communicate with the Internet or a local area network. In an instance, the transmission apparatus 2106 is a radio frequency (RF) module, which is configured to communicate with the Internet in a wireless manner.

In addition, the electronic device further includes: a display 2108, configured to display a virtual scene on an interface; and a connection bus 2110, configured to connect various module components in the electronic device.

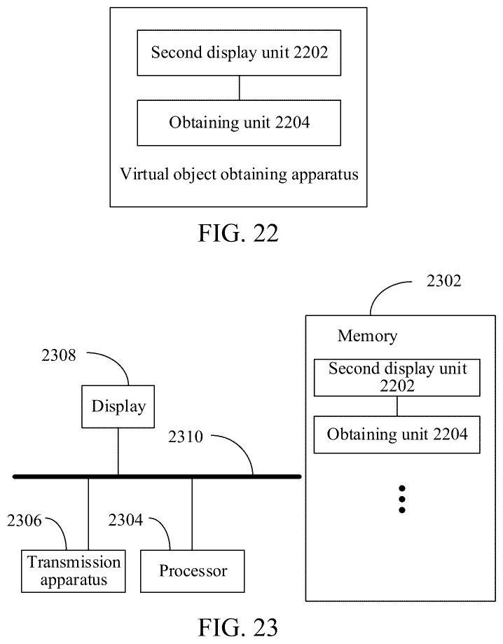

According to an embodiment of this disclosure, a virtual object obtaining apparatus for implementing the foregoing virtual object obtaining method is further provided. As shown in FIG. 22, the apparatus includes: a second display unit 2202, configured to: display, in a second object display region, at least one second virtual object possessed by a second account, the second virtual object being configured for performing a virtual interaction operation in a virtual scene; and display a sharing prompt region, and display a currently shared target virtual object in the sharing prompt region, when a first account performs a first interaction operation on the target virtual object, the first account and the second account being in the same interaction camp, and the target virtual object being configured for performing the virtual interaction operation in the virtual scene associated with the first account; and an obtaining unit 2204, configured to: display the target virtual object in the second object display region, and cancel displaying of the sharing prompt region, when receiving object sharing information transmitted by the first account.

In the foregoing solution, the second display unit 2202 includes: an obtaining module, configured to determine, in a first object display region on a current interaction interface of the first account, a first virtual object currently possessed by the first account, the first virtual object including the target virtual object; and a display module, configured to display the first virtual object in the sharing prompt region.

In the foregoing solution, the virtual object obtaining apparatus further includes a transmitting unit, configured to perform one of the following processing: transmitting first interaction prompt information to the first account in response to performing the first interaction operation on the target virtual object, the first interaction prompt information indicating that the second account agrees to receive the target virtual object; transmitting second interaction prompt information to the first account in response to performing a second interaction operation on the target virtual object, the second interaction prompt information indicating that the second account refuses to receive the target virtual object; or transmitting third interaction prompt information to the first account in response to performing a third interaction operation on a reference virtual object, the third interaction prompt information being configured for obtaining the reference virtual object currently possessed by the first account, and the reference virtual object being a first virtual object other than the target virtual object.

In the foregoing solution, the virtual object obtaining apparatus further includes an adjustment unit, configured to perform at least one of the following processing: adjusting a region display area of the sharing prompt region, and keeping displaying, in an adjusted sharing prompt region, the target virtual object and operation controls corresponding to the target virtual object, in response to a first region adjustment operation, the operation controls including a first operation control configured for indicating that the target virtual object is agreed to be received and a second operation control configured for indicating that the target virtual object is refused to be received; and adjusting a region display location of the sharing prompt region in response to a second region adjustment operation.

According to an embodiment of this disclosure, a non-transitory computer-readable storage medium is further provided. The non-transitory computer-readable storage medium has a computer program or computer-executable instructions stored therein. When the computer program or the computer-executable instructions are run, the virtual object sharing method is performed, or the virtual object obtaining method is performed.

In one or more embodiments, for embodiments to be implemented by the foregoing unit modules, refer to the foregoing method embodiments. Details are not described herein again.

According to an embodiment of this disclosure, an electronic device for implementing the foregoing virtual object obtaining method is further provided. The electronic device may be a terminal device or a server shown in FIG. 23. In this embodiment, an example in which the electronic device is the terminal device is used for description. As shown in FIG. 23, the electronic device includes a memory 2302 and processing circuitry, such as a processor 2304.

The memory 2302 has a computer program or computer-executable instructions stored therein. The processor 2304 is configured to implement operations in any one of the foregoing method embodiments when executing the computer program or the computer-executable instructions operations.

In this embodiment, the foregoing electronic device may be located in at least one of a plurality of network devices in a computer network.

In this embodiment, the foregoing processor may be configured to perform the following operations by using the computer program or the computer-executable instructions:

S1. Display, in a second object display region, at least one second virtual object possessed by a second account, the second virtual object being configured for performing a virtual interaction operation in a virtual scene.

S2. Display a sharing prompt region, and display a currently shared target virtual object in the sharing prompt region, when a first account performs a first interaction operation on the target virtual object, the first account and the second account being in the same interaction camp, and the target virtual object being configured for performing the virtual interaction operation in the virtual scene associated with the first account.

S3. Display the target virtual object in the second object display region, and cancel displaying of the sharing prompt region, when receiving object sharing information transmitted by the first account.

A person of ordinary skill in the art may understand that a structure shown in FIG. 23 is merely schematic. The electronic device may alternatively be a terminal device such as a smartphone, a tablet computer, a palmtop computer, a mobile Internet device (MID), or a pad. FIG. 23 does not constitute a limitation on a structure of the electronic device. For example, the electronic device may further include more or fewer components (for example, a network interface) than those shown in FIG. 23, or has a configuration different from that shown in FIG. 23.

The memory 2302 may be configured to store a software program and a module, such as a program instruction/module corresponding to the virtual object obtaining method and apparatus in one or more embodiments of this disclosure. The processor 2304 executes the software program and the module stored in the memory 2302, to perform various function applications and data processing, that is, implement the foregoing virtual object obtaining method. The memory 2302 may include a high speed random access memory, and may further include a non-volatile memory, such as one or more magnetic storage apparatuses, a flash memory, or another non-volatile solid state memory. In some instances, the memory 2302 may further include memories remotely disposed relative to the processor 2304. The remote memories may be connected to a terminal via a network. Instances of the network include, but are not limited to, the Internet, an Intranet, a local area network, a mobile communication network, and a combination thereof. The memory 2302 may be specifically, but is not limited to, configured to store information such as obtaining information of various elements and virtual objects in a scene picture. In an example, as shown in FIG. 23, the memory 2302 may include, but is not limited to, the second display unit 2202 and the obtaining unit 2204 in the foregoing virtual object obtaining apparatus. Furthermore, the memory 2302 may further include, but is not limited to, another module unit in the virtual object obtaining apparatus. Details are not described again in this example.

In some implementations, a transmission apparatus 2306 is configured to receive or transmit data via a network. Specific instances of the foregoing network may include a wired network and a wireless network. In an instance, the transmission apparatus 2306 includes a network interface controller (NIC). The NIC may be connected to another network device and a router through a network cable, to communicate with the Internet or a local area network. In an instance, the transmission apparatus 2306 is a radio frequency (RF) module, which is configured to communicate with the Internet in a wireless manner.

In addition, the electronic device further includes: a display 2308, configured to display a virtual scene on an interface; and a connection bus 2310, configured to connect various module components in the electronic device.

In other embodiments, the terminal device or the server may be a node in a distributed system, where the distributed system may be a blockchain system. The blockchain system may be a distributed system formed by a plurality of nodes connected in the form of network communication. A peer to peer (P2P) network may be formed between the nodes. Any form of computing device, such as the server, the terminal, and another electronic device, may become a node in the blockchain system by joining the peer-to-peer network.

An embodiment of this disclosure further provides a computer program product. The computer program product includes a computer program or computer-executable instructions. The computer program or the computer-executable instructions include program code configured for performing the methods shown in the flowcharts. In such an embodiment, the computer program or the computer-executable instructions may be downloaded and installed from the network through a communication part, and/or may be installed from a removable medium. When the computer program or the computer-executable instructions are executed by a central processing unit, various functions provided in one or more embodiments of this disclosure are executed.

The sequence numbers of the foregoing embodiments of this disclosure are merely for description, and are not intended to indicate priorities of embodiments.

An embodiment of this disclosure provides a non-transitory computer-readable storage medium. A processor of an electronic device reads a computer program or computer-executable instructions from the non-transitory computer-readable storage medium. The processor executes the computer program or the computer-executable instructions, so that the electronic device performs the virtual object sharing method or the virtual object obtaining method.

In this embodiment, the non-transitory computer-readable storage medium may be configured to store a computer program for executing the following operations:

S1. Display, in a first object display region, at least one first virtual object possessed by a first account, the first virtual object being configured for performing a virtual interaction operation in a virtual scene.

S2. Display a sharing prompt region, and display, in the sharing prompt region, a second virtual object currently possessed by a second account, in response to a first interaction operation on a target virtual object in the at least one first virtual object, the second account and the first account being in the same interaction camp, and the second virtual object being configured for performing the virtual interaction operation in the virtual scene associated with the second account.

S3. Cancel displaying of the target virtual object in the first object display region, and transmit object sharing information to the second account, in response to a second interaction operation, the object sharing information being configured for transferring the target virtual object to the second account for possessing.

In this embodiment, the non-transitory computer-readable storage medium may further be configured to store a computer program for executing the following operations:

S1. Display, in a second object display region, at least one second virtual object possessed by a second account, the second virtual object being configured for performing a virtual interaction operation in a virtual scene.

S2. Display a sharing prompt region, and display a currently shared target virtual object in the sharing prompt region, when a first account performs a first interaction operation on the target virtual object, the first account and the second account being in the same interaction camp, and the target virtual object being configured for performing the virtual interaction operation in the virtual scene associated with the first account.

S3. Display the target virtual object in the second object display region, and cancel displaying of the sharing prompt region, when receiving object sharing information transmitted by the first account.

In this embodiment, a person of ordinary skill in the art may understand that all or some of the steps of various methods in the foregoing embodiments may be completed by a program instructing relevant hardware of a terminal device. The program may be stored in a non-transitory computer-readable storage medium. The storage medium may include: a flash drive, a read-only memory (ROM), a random access memory (RAM), a magnetic disk, an optical disc, or the like.

If the integrated unit in the foregoing embodiments is implemented in a form of a software functional unit, and is sold or used as an independent product, the unit may be stored in the non-transitory computer-readable storage medium. Based on such an understanding, all or a part of the technical solutions in this disclosure may be implemented in a form of a software product. The computer software product is stored in a storage medium, and includes several instructions for instructing one or more electronic devices (which may be a personal computer, a server, a network device, or the like) to perform all or a part of steps of the methods in one or more embodiments of this disclosure.

In the foregoing embodiments of this disclosure, the descriptions of each embodiment have respective focus. For a part that is not described in detail in an embodiment, refer to related descriptions in other embodiments.

In the several embodiments provided in this disclosure, the disclosed client may be implemented in another manner. The foregoing apparatus embodiment is merely an example. For example, the division into the units is merely logical function division, and may be other divisions in other implementations. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the units or modules may be implemented in electrical or other forms.

The units described as separate parts may or may not be physically separate, and parts displayed as units may or may not be physical units, that is, may be located in one location, or may be distributed on a plurality of network units. Some or all of the units may be selected based on various requirements to achieve the objectives of the solutions in one or more embodiments.

In addition, functional units in one or more embodiments of this disclosure may be integrated into one processing unit, each of the units may exist alone physically, or two or more units are integrated into one unit. The integrated unit may be implemented in a form of hardware, or may be implemented in a form of a software functional unit.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (for example, computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The foregoing descriptions are merely non-limiting examples of implementations. Any modification, equivalent replacement, improvement, and the like made within the spirit and scope of this disclosure shall fall within the scope of this disclosure.

What is claimed is:

1. A virtual object sharing method, comprising:
displaying, in a first object display region, at least one first virtual object possessed by a first account, the first virtual object being configured to perform first one or more virtual interaction operations in a virtual environment;
displaying, in a sharing prompt region, at least one second virtual object possessed by a second account, based on a first interaction operation on a target virtual object in the at least one first virtual object, the second virtual object being configured to perform second one or more virtual interaction operations in the virtual environment;
based on a second interaction operation,
stopping, by processing circuitry, the display of the target virtual object in the first object display region; and
transmitting, by the processing circuitry, object sharing information of a virtual object transfer operation to the second account, the virtual object transfer operation being configured to transfer the target virtual object from the first account to the second account based on the object sharing information.

2. The method according to claim 1, wherein the displaying, in the sharing prompt region, the at least one second virtual object comprises:
determining, in a second object display region on a current interaction interface operated by the second account, the second virtual object currently possessed by the second account; and
displaying the second virtual object in the sharing prompt region.

3. The method according to claim 2, wherein the displaying, in the sharing prompt region, the at least one second virtual object comprises:
updating the display of the second virtual object in the sharing prompt region based on a change of the second virtual object in the second object display region.

4. The method according to claim 3, wherein the updating the display of the second virtual object in the sharing prompt region comprises one or more of:
stopping the display of the second virtual object in the sharing prompt region when the current interaction interface operated by the second account indicates moving the second virtual object displayed in the second object display region to displayed in an object interaction region on the current interaction interface, the second one or more virtual interaction operations being performed when the second virtual object is displayed in the object interaction region;
correspondingly adjusting display of a level identifier of the second virtual object in the sharing prompt region when a level of the second virtual object displayed in the second object display region is adjusted; or
updating display of a display location of the second virtual object in the sharing prompt region when the second virtual object displayed in the second object display region moves from a first display location to a second display location.

5. The method according to claim 1, further comprising:
generating sharing prompt information based on an object association relationship between the second virtual object and the target virtual object, the object association relationship being based on respective object attributes of the second virtual object and the target virtual object, and the sharing prompt information indicating a virtual gain effect provided by the target virtual object when the target virtual object is possessed the second account; and
displaying the sharing prompt information and the second virtual object in the sharing prompt region.

6. The method according to claim 5, wherein the displaying the sharing prompt information and the second virtual object in the sharing prompt region comprises:
highlighting, in the sharing prompt region when the virtual gain effect corresponds to increasing an object level of the second virtual object, the second virtual object and a level identifier corresponding to an increased level of the second virtual object; or
displaying, when the virtual gain effect corresponds to increasing an object interworking gain of the second virtual object, the second virtual object and the object interworking gain in the sharing prompt region, the object interworking gain indicating an effect on one or more other virtual objects that are of a same type of the second virtual object.

7. The method according to claim 6, wherein the displaying the second virtual object and the object interworking gain in the sharing prompt region comprises:
displaying the second virtual object in the sharing prompt region;
displaying a sliding list in the sharing prompt region, the sliding list indicating a subset of an object interworking gain list at a time, the object interworking gain list including one or more recorded object interworking gains of one or more combinations of the second virtual object and respective one or more virtual objects;
based on a target object interworking gain of possessing the second virtual object and the target virtual object being included in the object interworking gain list, updating the display of the sliding list with a sliding effect such that the sliding list indicates at least the target object interworking gain, and updating configuration progress information of the target object interworking gain; and
based on the target object interworking gain being not included in the object interworking gain list, adding the target object interworking gain to the object interworking gain list and adding configuration progress information of the target object interworking gain.

8. The method according to claim 1, further comprising, during the display of the sharing prompt region based on the first interaction operation:
displaying the target virtual object in a first style in the sharing prompt region when an object quantity of a set of virtual objects currently possessed by the second account is less than a quantity threshold, the target virtual object in the first style indicating that the second account is allowed to receive the target virtual object; and
displaying the sharing prompt information in a second style in the sharing prompt region when an object quantity of the set of virtual objects currently possessed by the second account is greater than or equal to the quantity threshold, the sharing prompt information in the second style indicating that the second account is not allowed to receive the target virtual object.

9. The method according to claim 8, wherein, based on the displaying the target virtual object in a first style in the sharing prompt region, the method further comprises one or more of:
displaying, when receiving first interaction prompt information transmitted by the second account, the first interaction prompt information on a current interaction interface operated by the first account, the first interaction prompt information indicating that the second account agrees to receive the target virtual object;
displaying, when receiving second interaction prompt information transmitted by the second account, the second interaction prompt information on the current interaction interface, the second interaction prompt information indicating that the second account refuses to receive the target virtual object; or
highlighting, when receiving third interaction prompt information transmitted by the second account, a reference virtual object in the first object display region on the current interaction interface based on the third interaction prompt information, the third interaction prompt information indicating a transfer request of the reference virtual object from the first account, and the reference virtual object being one of the at least one first virtual object other than the target virtual object.

10. The method according to claim 8, wherein, based on the first interaction operation corresponding to moving an interaction operation identifier to a target display region within the first object display region in which the target virtual object is displayed, the method further comprises:
stopping the display of the target virtual object in the first object display region, and stopping the display of the sharing prompt region, based on an operation of releasing the interaction operation identifier in the target display region; or
stopping the display of the target virtual object in the first object display region, and keeping the display the target virtual object in the first object display region, based on to an operation of releasing the interaction operation identifier in a region outside the target display region.

11. The method according to claim 9, wherein, based on the first interaction operation corresponding to moving an interaction operation identifier and based on the reference virtual object being highlighted in the first object display region, the method further comprises:
displaying the reference virtual object in the first style in the sharing prompt region based on a drag end point of a dragging operation of the interaction operation identifier falling within a reference display region, the reference display region being a region in the first object display region and in which the reference virtual object is displayed; and
stopping display of the reference virtual object in the first object display region and stopping the display of the sharing prompt region based on a release operation of the dragging operation when the drag end point is in the reference display region.

12. The method according to claim 1, further comprising:
determining, prior to the displaying a sharing prompt region and when a plurality of teammate accounts is included in a same interaction camp as the first account, two or more teammate accounts of the plurality of teammate accounts as selected receiving accounts based on a third interaction operation, the two or more teammate accounts including the second account and one or more additional second accounts; and
displaying, based on the first interaction operation on the target virtual object, one or more other sharing prompt regions respectively corresponding to the one or more additional second accounts.

13. The method according to claim 1, further comprising:
determining, prior to the displaying a sharing prompt region and when a plurality of teammate accounts is included in a same interaction camp as the first account, the second account in the plurality of teammate accounts based on a fourth interaction operation.

14. A virtual object obtaining method, comprising:
displaying, in a second object display region, at least one second virtual object possessed by a second account, the second virtual object being configured to perform second one or more virtual interaction operations in a virtual environment;
displaying a sharing prompt region and, in the sharing prompt region, a target virtual object possessed by a first account, the target virtual object being configured to perform first one or more virtual interaction operations in the virtual environment; and
when object sharing information associated with the first account is received,
displaying, by processing circuitry, the target virtual object in the second object display region; and
stopping, by the processing circuitry, the display of the sharing prompt region.

15. The method according to claim 14, wherein the displaying the sharing prompt region comprises:
determining, in a first object display region on a current interaction interface operated by the first account, the target virtual object from at least one first virtual object currently possessed by the first account; and
displaying the at least one first virtual object in the sharing prompt region.

16. The method according to claim 14, further comprising:
transmitting first interaction prompt information to the first account based on the first interaction operation on the target virtual object, the first interaction prompt information indicating that the second account agrees to receive the target virtual object;
transmitting second interaction prompt information to the first account based on a second interaction operation on the target virtual object, the second interaction prompt information indicating that the second account refuses to receive the target virtual object; or
transmitting third interaction prompt information to the first account based on a third interaction operation on a reference virtual object, the third interaction prompt information indicating a transfer request of the reference virtual object currently possessed by the first account, and the reference virtual object being one of the at least one first virtual object other than the target virtual object.

17. The method according to claim 14, further comprising:
adjusting a region display area of the sharing prompt region, and displaying, in an adjusted sharing prompt region, the target virtual object and operation controls corresponding to the target virtual object, based on a first region adjustment operation, the operation controls including a first operation control indicating that transfer of the target virtual object is agreed, and a second operation control indicating that the transfer of the target virtual object is refused; and
adjusting a region display location of the sharing prompt region in response to a second region adjustment operation.

18. A virtual object sharing apparatus, comprising:
processing circuitry configured to:
display, in a first object display region, at least one first virtual object possessed by a first account, the first virtual object being configured to perform first one or more virtual interaction operations in a virtual environment;
display, in a sharing prompt region, at least one second virtual object possessed by a second account, based on a first interaction operation on a target virtual object in the at least one first virtual object, the second virtual object being configured to perform second one or more virtual interaction operations in the virtual environment;
based on a second interaction operation,
stop the display of the target virtual object in the first object display region; and
transmit object sharing information of a virtual object transfer operation to the second account, the virtual object transfer operation being configured to transfer the target virtual object from the first account to the second account based on the object sharing information.

19. The virtual object sharing apparatus according to claim 18, wherein the processing circuitry is configured to:
generate sharing prompt information based on an object association relationship between the second virtual object and the target virtual object, the object association relationship being based on respective object attributes of the second virtual object and the target virtual object, and the sharing prompt information indicating a virtual gain effect provided by the target virtual object when the target virtual object is possessed the second account; and
display the sharing prompt information and the second virtual object in the sharing prompt region.

20. The virtual object sharing apparatus according to claim 18, wherein the processing circuitry is configured to, during the display of the sharing prompt region based on the first interaction operation:
display the target virtual object in a first style in the sharing prompt region when an object quantity of a set of virtual objects currently possessed by the second account is less than a quantity threshold, the target virtual object in the first style indicating that the second account is allowed to receive the target virtual object; and
display the sharing prompt information in a second style in the sharing prompt region when an object quantity of the set of virtual objects currently possessed by the second account is greater than or equal to the quantity threshold, the sharing prompt information in the second style indicating that the second account is not allowed to receive the target virtual object.
